(19) United States
(12) Patent Application Publication
(10) Pub. No.: US 2025/0110288 A1
(43) Pub. Date: Apr. 3, 2025

(54) OPTICAL CONNECTION TERMINAL, CONNECTION STRUCTURE FOR OPTICAL CONNECTION TERMINAL, AND METHOD FOR MAKING OPTICAL DEVICE

(71) Applicant: FURUKAWA ELECTRIC CO., LTD., Tokyo (JP)

(72) Inventors: Kengo Watanabe, Tokyo (JP); Shosuke Ikeda, Tokyo (JP); Tsunetoshi Saito, Tokyo (JP)

(21) Appl. No.: 18/899,671

(22) Filed: Sep. 27, 2024

(30) Foreign Application Priority Data
Oct. 3, 2023 (JP) 2023-171866
May 15, 2024 (JP) 2024-079751

(51) Int. Cl. G02B 6/38

(52) U.S. Cl. CPC G02B 6/3853; G02B 6/3861; G02B 6/3882; G02B 6/3885

(57) ABSTRACT

A lens array is accommodated inside a positioning member and fixed with adhesive, for example. The lens array is optically connected to a planar optical waveguide (an optical waveguide member). The planar optical waveguide includes a plurality of optical waveguide paths being formed therein, and each of the plurality of the optical waveguide paths is aligned and optically connected to each lens of the lens array and fixed with adhesive, for example. A guide mechanism is provided on a front surface of the positioning member (a surface facing a connection target) for positioning with the connection target. Here, it is preferable that the planar optical waveguide and the lens array are made of glass and the positioning member is made of thermoplastic resin.

### TECHNICAL FIELD

The present invention relates to an optical connection terminal that can be optically connected to a connection target, and a connection structure for optical connection terminals and the like using the same.

### BACKGROUND

In the fields of photoelectric fusion (such as co-packaged optics (CPO)) and silicon photonics (SiP), an optical connection mechanism for connecting a photonic integrated circuit (PIC) etc. to optical fibers is to be used.

FIG. 57 is a schematic view showing a part of an optical device having a conventional optical connection structure. A PIC (a photonic integrated circuit 101) such as SiP and integrated circuits and the like are mounted on a substrate 100, and optical fibers 103 are connected to the photonic integrated circuit 101. Connectors 105 for connection with other devices are connected to ends of the optical fibers 103.

When building such the optical connection structure, the substrate 100 and the photonic integrated circuit 101 are connected to each other through a reflow process, for example. However, if a large number of such the optical fibers 103 attached with the connectors 105 are connected to the substrate 100, handling becomes complicated, resulting in poor handling performance. Also, self-weight of the connectors 105 and pulling tension of the optical fibers 103 may apply stress onto a connected part with the photonic integrated circuit 101 and may damage the connected part. In addition, the optical fibers 103 and the connectors 105 are to have heat resistance to withstand the reflow process.

In contrast, Japanese Unexamined Patent Application Publication No. 2016-90614 (JP-A-2016-90614) has proposed a method in which optical wiring members are fixed by adhesion to stubs that are fixed onto a photonic integrated element after a reflow process. In JP-A-2016-90614, materials having excellent heat resistance are selected for the photonic integrated element, prisms, adhesive, and so on so as to withstand the reflow process, and connecting optical fibers after the reflow process can prevent the optical fibers and connectors from deterioration with heat.

However, as mentioned above, when connecting a large number of optical fibers to a substrate or the like, each of the optical fibers is to be aligned and fixed with adhesive. For this reason, the connection operation takes rather a long time and, in addition, the already connected optical fibers may get in the way of the alignment and connection operation of other optical fibers, resulting in poor operation.

### SUMMARY OF THE DISCLOSURE

The present invention was made in view of such problems. It is an object of the present invention to provide an optical connection terminal that can easily build an optical connection structure, and a connection structure for optical connection terminals and the like using the same.

To achieve the above object, a first aspect of the present invention is an optical connection terminal that can be optically connected to a connection target. The optical connection terminal includes a positioning member having a guide mechanism for the connection target, a lens array that is to be fixed to the positioning member, and an optical waveguide member that is to be optically connected to the lens array. The positioning member and the lens array are positioned and fixed to each other, and the lens array and the optical waveguide member are aligned and fixed to each other.

The lens array and the optical waveguide member may be made of silicon or glass, and the positioning member may be made of resin.

Difference in linear expansion coefficients between the lens array and the optical waveguide member may be 20 ppm/° C. or less.

The positioning member may include a positioning part with which a front surface of the lens array can be in surface contact, and there is a predetermined distance between a tip end of the lens array and a front surface of the positioning member.

A magnet that is to be a fixing portion with the connection target may be disposed on the front surface of the positioning member.

The guide mechanism may be disposed on each side of the lens array and may have a concave/convex structure that can be fitted with the connection target.

A gap may be provided between the optical waveguide member and the lens array.

A spacer may be disposed between the optical waveguide member and the lens array at a part other than optical paths.

The spacer and the lens array may be integrally formed and a thickness of the spacer may be 5 μm or more.

An interface between the optical waveguide member and the lens array may be formed obliquely to an optical axis direction of the optical waveguide member.

Optical waveguide paths in the optical waveguide member may be formed obliquely to an optical axis direction of the lens array.

A beam expansion diameter by the lens array may be 30 μm or more and 120 μm or less.

The front surface of the optical waveguide member may be 5 μm or more behind a back focal point position of the lens array.

A thickness of the positioning member may be 0.8 mm or more.

The thickness of the positioning member may be 1 mm or more.

A distance between a rear end surface of the lens array and a front end surface of the positioning member may be 1.7 mm or less.

A distance between a rear end surface of the optical waveguide member and the front end surface of the positioning member may be 12 mm or less.

The lens array may be inserted into the positioning member and fixed in a state in which outer surfaces of the lens array are pressed against at least two inner surfaces of the positioning member.

Convex/concave shapes corresponding to each other may be formed on the inner surfaces of the positioning member and the outer surfaces of the lens array, and the convex/concave shapes on the inner surfaces of the positioning member fit with the convex/concave shapes on the outer surfaces of the lens array and the lens array may be positioned to the positioning member.

The convex/concave shapes corresponding to each other may be formed on the inner surfaces of the positioning member and the outer surfaces of the lens array, and, when the lens array is pushed into the positioning member, the convex/concave shapes on the inner surfaces of the positioning member may elastically deform and the convex/concave shapes on the inner surfaces of the positioning member may fit with the convex/concave shapes on the outer surfaces of the lens array to be fixed in a state of close contact with each other.

The optical waveguide member may be an optical fiber array in which multicore fibers are arranged side by side.

A shrinkage percentage of the positioning member after being heated at 260° C. for one minute may be 0.13% or less.

More preferably, the shrinkage percentage of the positioning member after being heated at 260° C. for one minute may be 0.02% or less.

According to the first aspect of the present invention, a detachable optical connection terminal using a guide mechanism can be obtained. At this time, a lens array is used to expand beams and thus a tolerance with another facing optical connection terminal, which is a connection target, can be increased. Also, the lens array and a positioning member for positioning the connection target, which is to be optically connected with the lens array, are formed as separate members, and this can achieve an optical connection with high manufacturability and precision.

For example, if a lens array made of resin is used in a reflow process at 200° C. or more, high temperature resistance is insufficient. Also, large difference in linear expansion coefficients (CTE) between the lens array and an optical waveguide component (such as silicon photonics, a quartz-based waveguide, and an optical fiber array), which is to be the connection target, may cause misalignment of axes at the time of temperature change or breakage at the time of reflow. On the other hand, for a lens array made of a material with reflow resistance (such as Si or glass-based materials), it is difficult, in terms of manufacturing, to produce a guide hole for a position of the lens array part with high precision. That is, it becomes hard to form a guide mechanism for positioning with the connection target.

In contrast, according to the first aspect of the present invention, since the lens array and the positioning member are formed separately, by selecting materials that are suitable for respective functions, manufacturing thereof in a method that allows mass production is possible, and thus positioning with high precision and the optical connection with the connection target can be performed.

As for such the materials, making the lens array and the optical waveguide member from glass and the positioning member from resin can provide an optical connection structure with high precision. Also, since the lens array and the optical waveguide member are made of silicon or glass, difference in linear expansion coefficients is small and a high-precision alignment state can be maintained during the reflow process.

To obtain such effects with more certainty, it is preferable that the difference in the linear expansion coefficients between the lens array and the optical waveguide member is 20 ppm/° C. or less, for example. This can prevent misalignment of optical axes of the lens array and the optical waveguide member at the time of temperature change with more certainty. This also can contain dimension mismatch, which occurs due to thermal expansion at a high temperature (200° C. or more, for example) during the reflow process, within a tolerable range, which can prevent breakage due to detachment or deformation of fixing adhesive used between the lens array and the optical waveguide member.

Also, the positioning member includes the positioning part to which the front surface of the lens array can come in surface contact, and this allows the distance between the tip end of the lens array and the front surface of the positioning member to be kept constant. This can keep a suitable lens distance (e.g., twice a focal length is optimal) with the facing optical connection terminal, which is a connection target, and can prevent an increase in loss due to defocusing.

Also, a magnet that is to be a fixing portion for the connection target is disposed on the front surface of the positioning member, and this allows connecting the optical connection terminals to each other with a little force. Also, by adjusting magnetic force of the magnet, the force required for attaching and detaching the optical connection terminals can be minimized.

Also, if the guide mechanism is disposed on each side of the lens array and is in a concave/convex structure that can be fitted with the connection target, positioning with high precision can be performed similarly as a conventional MT ferule.

Also, a gap is provided between the optical waveguide member and the lens array. By utilizing such a space (refraction index), beams can be expanded efficiently. Also, if the space is filled up with a medium such as adhesive, parameters such as beam diameters can be arbitrarily adjusted by the refraction index of the medium.

Also, a spacer is disposed between the optical waveguide member and the lens array at a part other than optical paths. This enables to provide a gap between the optical waveguide member and the lens array with certainty.

Also, integrally forming the spacer and the lens array facilitates the assembling operation. At this time, having the spacer thickness of 5 μm or more enables to provide a gap of 5 μm or more between the optical waveguide member and the lens array with certainty.

Also, if an interface between the optical waveguide member and the lens array is formed obliquely to an optical axis direction of the optical waveguide member, an influence of reflective light at the interface can be reduced. For similar effects, an isolator may be disposed or an anti-reflection film may be provided on the interface.

Also, forming optical waveguide paths in the optical waveguide member obliquely to an optical axis direction of the lens array can also provide the above-mentioned similar effects.

Also, making the beam expansion diameter by the lens array 30 μm or more, or even 40 μm or more, can increase offset of the tolerated optical axes. Also, making the beam expansion diameter by the lens array 120 μm or less, or even 80 μm or less, can reduce loss due to tilting of the optical axes and can achieve high-density packaging.

Also, the front surface of the optical waveguide member is 5 μm or more, or even 10 μm or more, behind a back focal point position of the lens array. Thus, even if a distance between the lens arrays is larger than an ideal distance, misalignment of the beam focal points can be suppressed.

Also, in such the case, making the thickness of the positioning member 0.8 mm or more, or even 1 mm or more, facilitates manufacturing and handling of the positioning member.

Also, making the beam diameter a predetermined value or less can decrease a length of an optically connected part in the optical axis direction. For example, a distance between a rear end surface of the lens array and a front end surface of the positioning member can be 1.7 mm or less, or even 1.2 mm or less. Also, a distance between a rear end surface of the optical waveguide member and the front end surface of the positioning member can be 12 mm or less, or even 7 mm or less.

Also, when the lens array is inserted into the positioning member, by fixing the positioning member and the lens array to each other in a state in which outer surfaces of the lens array are pressed against at least two inner surfaces of the positioning member, the positioning member and the lens array can be positioned with high precision and then fixed.

Also, forming convex/concave shapes corresponding to each other on the inner surfaces of the positioning member and the outer surfaces of the lens array such that the convex/concave shapes on the inner surfaces of the positioning member fit with the convex/concave shapes on the outer surfaces of the lens array allows the lens array to be positioned to the positioning member with high precision.

Furthermore, when the lens array is pushed into the positioning member, the convex/concave shapes on the inner surfaces of the resin-made positioning member elastically deform and the convex/concave shapes on the inner surfaces of the positioning member fit with the convex/concave shapes on the outer surfaces of the lens array to be fixed being in a close contact with each other. This allows the positioning member and the lens array to be positioned with high precision and then fixed.

Also, if the optical waveguide member is an optical fiber array in which multicore fibers are arranged side by side, multiple optical connections can be performed collectively.

Also, if the shrinkage percentage of the positioning member after being heated at 260° C. for one minute is 0.13% or less, misalignment of positions etc. in the reflow process can be suppressed and high connection precision with the connection target can be maintained.

Also, if the shrinkage percentage of the positioning member after being heated at 260° C. for one minute is even 0.02% or less, the misalignment of the positions etc. in the reflow process can be suppressed and higher connection precision with the connection target can be maintained, which is preferable.

A second aspect of the present invention is a connection structure for optical connection terminals. A first one of the optical connection terminals includes a first positioning member, a first lens array that is to be fixed to the first positioning member, and a first optical waveguide member that is to be optically connected to the first lens array. A second one of the optical connection terminals, which is to be connected to the first one of the optical connection terminals, includes a second positioning member, a second lens array that is to be fixed to the second positioning member, and a second optical waveguide member that is to be optically connected to the second lens array. When the first positioning member and the second positioning member are connected, there is a space formed at an optically connected part between the first lens array and the second lens array.

The first optical waveguide member may be a planar optical waveguide and the second optical waveguide member may be an optical fiber array.

One side of the first positioning member and the second positioning member may be provided with a male-side hole and a guide pin that is to be inserted into the male-side hole and fixed. The other side of the first positioning member and the second positioning member may be provided with a female-side hole into/from which the guide pin can be inserted/removed. A diameter of the female-side hole may be 1 μm or more larger than a diameter of the male-side hole. When the first positioning member and the second positioning member are connected, the guide pin may be inserted into the female-side hole and the first positioning member and the second positioning member are positioned to each other.

One side of the first positioning member and the second positioning member may be provided with a male-side hole and a guide pin that is to be pressed and fitted into the male-side hole and fixed. The other side of the first positioning member and the second positioning member may be provided with a female-side hole into/from which the guide pin can be inserted/removed. A diameter of the female-side hole may be larger than an outer diameter of the guide pin. When the first positioning member and the second positioning member are connected, the guide pin may be inserted into the female-side hole and the first positioning member and the second positioning member are positioned to each other.

An insertion length of the guide pin in the female-side hole may be 1 mm or less.

An interface between the first optical waveguide member and the first lens array may be formed obliquely to an optical axis direction of the first lens array, and an interface between the second optical waveguide member and the second lens array may be formed obliquely to an optical axis direction of the second lens array. When the first positioning member and the second positioning member are connected, the interface between the first optical waveguide member and the first lens array may be substantially parallel to the interface between the second optical waveguide member and the second lens array.

The interface between the first optical waveguide member and the first lens array may be formed obliquely to the optical axis direction of the first lens array, and the interface between the second optical waveguide member and the second lens array may be formed obliquely to the optical axis direction of the second lens array. When the first positioning member and the second positioning member are connected, the interface between the first optical waveguide member and the first lens array and the interface between the second optical waveguide member and the second lens array may be substantially linearly symmetrical with a connected part as an axis of symmetry.

An optical path of the first optical waveguide member may be formed obliquely to the optical axis direction of the first lens array, and an optical path of the second optical waveguide member may be formed obliquely to the optical axis direction of the second lens array. When the first positioning member and the second positioning member are connected, the optical path of the first optical waveguide member and the optical path of the second optical waveguide member may be substantially linearly symmetrical with the connected part as an axis of symmetry.

A plurality of the first ones of the optical connection terminals may be disposed onto a substrate, and a plurality of the second ones of the optical connection terminals may be fixed collectively by a housing. The plurality of the first ones of the optical connection terminals may be optically connected to the plurality of the second ones of the optical connection terminals that are integrated by the housing.

The plurality of the first ones of the optical connection terminals may be disposed onto a substrate, and a plurality of the second lens arrays are fixed to the second positioning member in the second one of the optical connection terminals. Each of the second optical waveguide members may be optically connected to each of the second lens arrays, and each of the first lens arrays of the plurality of the first ones of the optical connection terminals and the plurality of the second lens arrays integrated by the second positioning member may be optically connected.

According to the second aspect of the present invention, when the first positioning member and the second positioning member are connected, the first optical waveguide member does not come into contact with the second optical waveguide member, creating a space at the optically connected part, and this allows a distance between lenses to be kept at an optimal focal length.

Also, furthermore, expanding beams by using the lens array can increase the tolerance of position misalignment with the facing optical connection terminal.

As such the connection structure for optical connection terminals, if the first optical waveguide member of the first optical connection terminal is a planar optical waveguide and the second optical waveguide member of the second optical connection terminal is an optical fiber array, by fixing the first optical connection terminals to a substrate through reflow and then connecting the second optical connection terminals to the respective first optical connection terminals, an optical device can be assembled efficiently.

Also, by providing a guide pin to be inserted into and fixed to a male-side hole on one side of the first positioning member and the second positioning member and by providing a female-side hole into which the guide pin is to be inserted on the other side, the first positioning member and the second positioning member can be connected to each other with high precision. At this time, pressing and fitting the guide pin into the male-side hole can suppress tilting or shifting of the guide pin. Also, making a diameter of the female-side hole larger than an outer diameter of the guide pin can reduce insertion resistance of the guide pin.

Also, making the diameter of the female-side hole 1 μm or more larger than a diameter of the male-side hole can suppress an error range of positioning of the two, allowing mutual positioning to have high precision.

Also, by making an insertion length of the guide pin in the female-side hole 1 mm or less, friction between the guide pin and the female-side hole at the time of fitting can be reduced and, at the same time, can tolerate play in the positioning.

Also, in a case in which the interface between the first optical waveguide member and the first lens array is formed obliquely to an optical axis direction of the first lens array and the interface between the second optical waveguide member and the second lens array is formed obliquely to an optical axis direction of the second lens array, by connecting the two such that the interface between the first optical waveguide member and the first lens array is substantially parallel to the interface between the second optical waveguide member and the second lens array, a distance of each optical path (the sum of optical paths of the first lens array and the second lens array) can be kept substantially constant.

In contrast, in the case in which the interface between the first optical waveguide member and the first lens array is formed obliquely to the optical axis direction of the first lens array and the interface between the second optical waveguide member and the second lens array is formed obliquely to the optical axis direction of the second lens array, by connecting the two such that the interface between the first optical waveguide member and the first lens array and the interface between the second optical waveguide member and the second lens array are substantially linearly symmetrical with a center line passing through a border of the connected part as an axis of symmetry, oblique emission and oblique incidence at the interfaces can be compensated.

Also, in the case in which optical paths (optical waveguide paths) of the first optical waveguide member are formed obliquely to the optical axis direction of the first lens array, and optical paths (optical waveguide paths) of the second optical waveguide member are formed obliquely to the optical axis direction of the second lens array, by connecting the two such that the interface between the first optical waveguide member and the first lens array and the interface between the second optical waveguide member and the second lens array are substantially linearly symmetrical with a center line passing a border of the connected part as an axis of symmetry, oblique emission and oblique incidence at the interfaces can be compensated.

Also, in the case in which a plurality of the first ones of the optical connection terminals are disposed onto a substrate, and a plurality of the second ones of the optical connection terminals are fixed collectively by a housing, the plurality of the first ones of the optical connection terminals can be optically connected to the plurality of the second ones of the optical connection terminals that are integrated by the housing.

Also, in the case in which the plurality of the first ones of the optical connection terminals are disposed onto a substrate, by fixing the plurality of the second lens arrays to the second positioning member of the second ones of the optical connection terminals, the plurality of the second lens arrays integrated by the second positioning member can be optically connected collectively to the plurality of the first ones of the optical connection terminals.

A third aspect of the present invention is a method for manufacturing an optical device using the connection structure for optical connection terminals according to the second aspect of the present invention. The method includes a step ‘a’ of disposing the first one of the optical connection terminals onto an electronic circuit substrate to be connected with the electronic circuit substrate through reflow, and a step ‘b’ following the step ‘a’ of connecting the second one of the optical connection terminals to the first one of the optical connection terminals.

According to the third aspect of the present invention, there are no optical fibers and the like in the reflow process, which facilitates handling as well as the connection operation that follows thereafter.

The present invention can provide an optical connection terminal that can easily build an optical connection structure, and a connection structure for optical connection terminals and the like using the same.

### BRIEF DESCRIPTION OF DRAWINGS

FIG. 1A is a side view showing a process of connecting an optical connection terminals 10 and 20.

FIG. 1B is a cross-sectional view taken along A-A line in FIG. 1A.

FIG. 2A is a view from a direction of an arrow B-B in FIG. 1A.

FIG. 2B is a view from a direction of an arrow C-C in FIG. 1A.

FIG. 3A is a side view showing a process of connecting the optical connection terminals 10 and 20.

FIG. 3B is a cross-sectional view taken along D-D line in FIG. 3A.

FIG. 4 is a cross-sectional view taken along Z-Z line in FIG. 3A.

FIG. 5 is a view showing a positional relation between lens arrays 3a and 3b.

FIG. 6 is a view showing dimensions of the optical connection terminal 10.

FIG. 7A is a view showing an assembly process of a connection structure for optical connection terminals.

FIG. 7B is a view showing an assembly process of the connection structure for optical connection terminals.

FIG. 7C is a view showing an assembly process of the connection structure for optical connection terminals.

FIG. 8A is a view showing an assembly process of the connection structure for optical connection terminals.

FIG. 8B is a view showing an assembly process of the connection structure for optical connection terminals.

FIG. 8C is a view showing an assembly process of the connection structure for optical connection terminals.

FIG. 9A is a view showing another method for alignment in the assembly process of the connection structure for optical connection terminals.

FIG. 9B is a view showing another method for alignment in the assembly process of the connection structure for optical connection terminals.

FIG. 10A is a view showing an assembly process of an optical device 50.

FIG. 10B is a view showing an assembly process of the optical device 50.

FIG. 10C is a view showing an assembly process of the optical device 50.

FIG. 11 is a view showing other guide mechanisms 9a and 9b in the optical connection terminals 10 and 20.

FIG. 12A is a schematic view showing misalignment between positioning members 1a and 1b in the guide mechanism 9a and 9b.

FIG. 12B is a schematic view showing misalignment between the positioning members 1a and 1b in the guide mechanism 9a and 9b.

FIG. 12C is a schematic view showing misalignment between the positioning members 1a and 1b in the guide mechanism 9a and 9b.

FIG. 13A is a schematic view showing misalignment between the positioning members 1a and 1b in the guide mechanism 9a and 9b.

FIG. 13B is a schematic view showing misalignment between the positioning members 1a and 1b in the guide mechanism 9a and 9b.

FIG. 13C is a schematic view showing misalignment between the positioning members 1a and 1b in the guide mechanism 9a and 9b.

FIG. 14 is a view showing another fixing structure for a guide pin 61.

FIG. 15 is a view showing another fixing structure for the guide pin 61.

FIG. 16A is a view showing another fixing structure for the guide pin 61.

FIG. 16B is a view showing another fixing structure for the guide pin 61.

FIG. 17A is a view showing another structure for the lens array 3a and the positioning member 1a.

FIG. 17B is a view showing another structure for the lens array 3a and the positioning member 1a.

FIG. 18A is a view showing a positioning structure for the lens array 3a and the positioning member 1a.

FIG. 18B is a view showing a positioning structure for the lens array 3b and the positioning member 1b.

FIG. 19A is a view showing another positioning structure for the lens array 3a and the positioning member 1a.

FIG. 19B is a view showing another positioning structure for the lens array 3a and the positioning member 1a.

FIG. 20A is a view showing another positioning structure for the lens array 3a and the positioning member 1a.

FIG. 20B is a view showing another positioning structure for the lens array 3a and the positioning member 1a.

FIG. 21A is a schematic view showing a propagation state of a beam 77.

FIG. 21B is a schematic view showing a propagation state of the beam 77.

FIG. 21C is a schematic view showing a propagation state of the beam 77.

FIG. 22 is a schematic view showing a positional relation between the lens arrays 3a and 3b and optical waveguide members.

FIG. 23A is a side view showing a structure of another optical connection terminal 10.

FIG. 23B is a cross-sectional view of FIG. 23A.

FIG. 23C is a side view showing a structure of another optical connection terminal 10.

FIG. 23D is a cross-sectional view of FIG. 23C.

FIG. 24A is a side view showing a structure of another optical connection terminal 10.

FIG. 24B is a cross-sectional view of FIG. 24A.

FIG. 25 is a cross-sectional view showing a structure of another optical connection terminal 10.

FIG. 26A is a side view showing a structure of another optical connection terminal 10.

FIG. 26B is a side view showing a structure of another optical connection terminal 10.

FIG. 27 is a view showing a connection structure for optical connection terminals 30a.

FIG. 28 is a view showing a connection structure for optical connection terminals 30b.

FIG. 29 is a view showing a connection structure for optical connection terminals 30c.

FIG. 30 is a cross-sectional view showing a structure of another optical connection terminal 10.

FIG. 31A is a side view showing a structure of another optical connection terminal 20.

FIG. 31B is a side view showing a structure of another optical connection terminal 20.

FIG. 32A is a view showing a variation of a fixing structure of the optical connection terminal to a substrate 51a.

FIG. 32B is a view showing a variation of the fixing structure of the optical connection terminal to the substrate 51a.

FIG. 33A is a view showing a variation of the fixing structure of the optical connection terminal to the substrate 51a.

FIG. 33B is a view showing a variation of the fixing structure of the optical connection terminal to the substrate 51a.

FIG. 33C is a view showing a variation of the fixing structure of the optical connection terminal to the substrate 51a.

FIG. 33D is a view showing a variation of the fixing structure of the optical connection terminal to the substrate 51a.

FIG. 34A is a front view of the optical connection terminal.

FIG. 34B is a view showing a variation of the fixing structure of the optical connection terminal to the substrate 51a.

FIG. 34C is a view showing a variation of the fixing structure of the optical connection terminal to the substrate 51a.

FIG. 35A is a front view of another optical connection terminal.

FIG. 35B is a view showing a variation of the fixing structure of the optical connection terminal to the substrate 51a.

FIG. 35C is a view showing a variation of the fixing structure of the optical connection terminal to the substrate 51a.

FIG. 36A is a view showing a variation of the fixing structure of the optical connection terminal to the substrate 51a.

FIG. 36B is a view showing a variation of the fixing structure of the optical connection terminal to the substrate 51a.

FIG. 36C is a view showing a variation of the fixing structure of the optical connection terminal to the substrate 51a.

FIG. 36D is a view showing a variation of the fixing structure of the optical connection terminal to the substrate 51a.

FIG. 36E is a view showing a variation of the fixing structure of the optical connection terminal to the substrate 51a.

FIG. 36F is a view showing a variation of the fixing structure of the optical connection terminal to the substrate 51a.

FIG. 37A is a view showing a variation of the fixing structure of the optical connection terminal to the substrate 51a.

FIG. 37B is a view showing a variation of the fixing structure of the optical connection terminal to the substrate 51a.

FIG. 37C is a view showing a variation of the fixing structure of the optical connection terminal to the substrate 51a.

FIG. 38A is a view from a direction of an arrow J in FIG. 37B.

FIG. 38B is a cross-sectional view taken along K-K line in FIG. 37C.

FIG. 39A is a view showing a variation of the fixing structure of the optical connection terminal to the substrate 51a.

FIG. 39B is a view showing a variation of the fixing structure of the optical connection terminal to the substrate 51a.

FIG. 39C is a view showing a variation of the fixing structure of the optical connection terminal to the substrate 51a.

FIG. 39D is a view showing a variation of the fixing structure of the optical connection terminal to the substrate 51a.

FIG. 40A is a view showing a variation of the fixing structure of the optical connection terminal to the substrate 51a.

FIG. 40B is a view showing a variation of the fixing structure of the optical connection terminal to the substrate 51a.

FIG. 40C is a view showing a variation of the fixing structure of the optical connection terminal to the substrate 51a.

FIG. 41A is a view showing a variation of the fixing structure of the optical connection terminal to the substrate 51a.

FIG. 41B is a view showing a variation of the fixing structure of the optical connection terminal to the substrate 51a.

FIG. 41C is a view showing a variation of the fixing structure of the optical connection terminal to the substrate 51a.

FIG. 42A is a view showing a variation of the fixing structure of the optical connection terminal to the substrate 51a.

FIG. 42B is a view showing a variation of the fixing structure of the optical connection terminal to the substrate 51a.

FIG. 42C is a view showing a variation of the fixing structure of the optical connection terminal to the substrate 51a.

FIG. 43A is a view showing a variation of the fixing structure of the optical connection terminal to the substrate 51a.

FIG. 43B is a view showing a variation of the fixing structure of the optical connection terminal to the substrate 51a.

FIG. 43C is a view showing a variation of the fixing structure of the optical connection terminal to the substrate 51a.

FIG. 44A is a view showing a variation of a connection structure between the optical connection terminals.

FIG. 44B is a view showing a variation of the connection structure between the optical connection terminals.

FIG. 44C is a view showing a variation of the connection structure between the optical connection terminals.

FIG. 45A is a view showing a variation of the connection structure between the optical connection terminals.

FIG. 45B is a view showing a variation of the connection structure between the optical connection terminals.

FIG. 46A is a view showing a connection structure between the optical connection terminals.

FIG. 46B is a front view of the optical connection terminal 10.

FIG. 46C is a front view of the optical connection terminal 20.

FIG. 47 is a view showing another connection structure between the optical connection terminal 10 and the optical connection terminal 20.

FIG. 48 is a view showing another connection structure between the optical connection terminal 10 and the optical connection terminal 20.

FIG. 49 is a view showing another connection structure between the optical connection terminal 10 and the optical connection terminal 20.

FIG. 50 is a view showing another connection structure between the optical connection terminal 10 and the optical connection terminal 20.

FIG. 51 is a view showing another connection structure between the optical connection terminal 10 and the optical connection terminal 20.

FIG. 52 is a view showing another connection structure between the optical connection terminal 10 and the optical connection terminal 20.

FIG. 53 is a view showing another connection structure between the optical connection terminal 10 and the optical connection terminal 20.

FIG. 54 is a view showing another connection structure between the optical connection terminal 10 and the optical connection terminal 20.

FIG. 55A is a view showing a connection structure between the optical connection terminals.

FIG. 55B is a view from a direction of an arrow P-P in FIG. 55A.

FIG. 55C is a cross-sectional view taken along Q-Q line in FIG. 55A.

FIG. 56 is a schematic view of optical paths at the time of optical connection in FIG. 55A.

FIG. 57 is a schematic view showing a conventional fixing structure of optical fibers 103 to a substrate 100.

### DETAILED DESCRIPTION

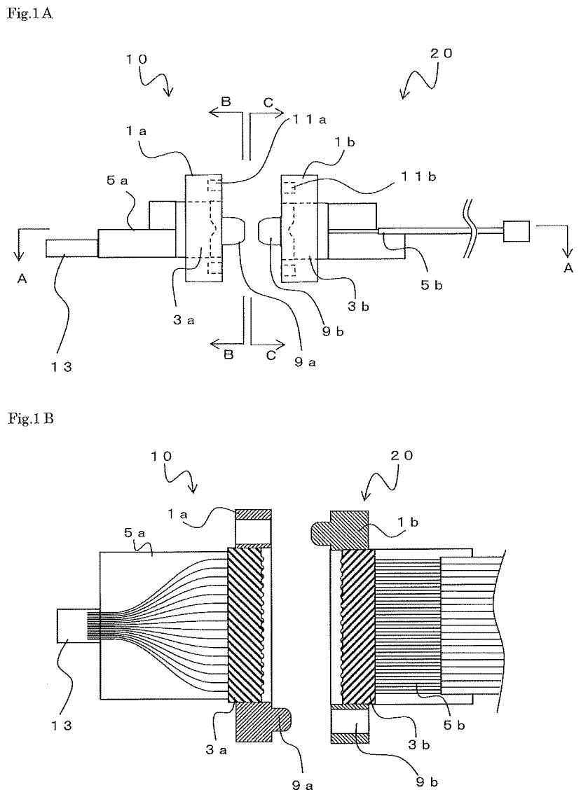

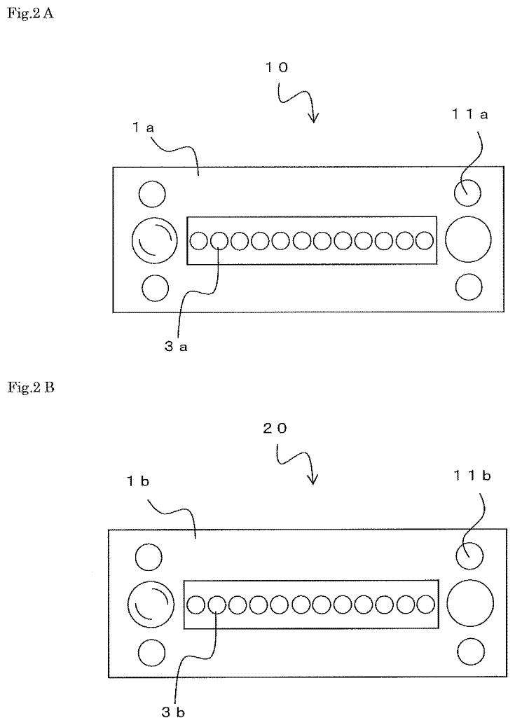

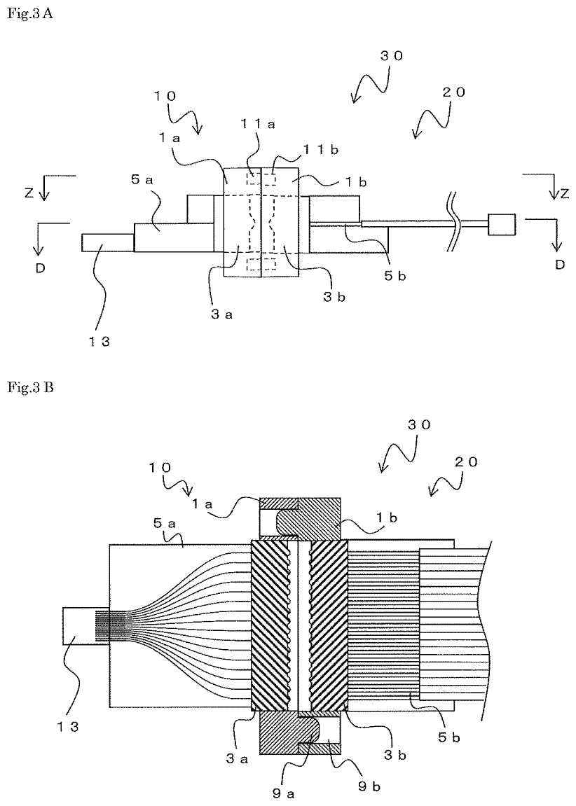

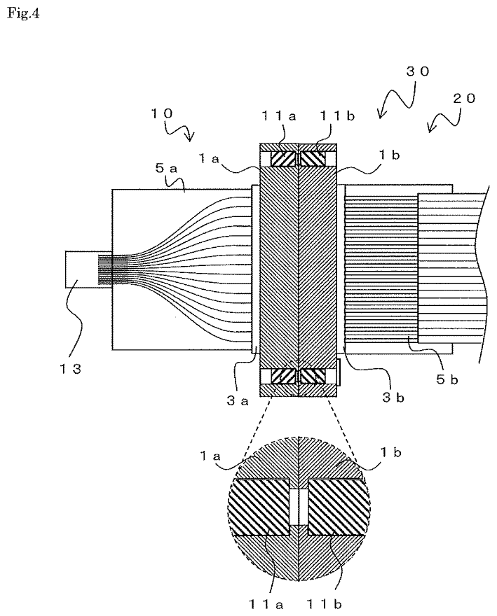

Hereinafter, optical connection terminals according to an embodiment of the present invention will be described. FIG. 1A is a side view showing an optical connection terminal 10 and an optical connection terminal 20, and FIG. 1B is a cross-sectional view taken along A-A line in FIG. 1A. Also, FIG. 2A is a view from a direction of an arrow B-B in FIG. 1A, and FIG. 2B is a view from a direction of an arrow C-C in FIG. 1A. Also, FIG. 3A is a side view of a connection structure for optical connection terminals in which the optical connection terminal 10 and the optical connection terminal 20 are optically connected to each other, and FIG. 3B is a cross-sectional view taken along D-D line in FIG. 3A. The optical connection terminals 10 and 20 can be connected to other connection targets, respectively.

The first optical connection terminal 10 includes a positioning member 1a, which is a first positioning member, a lens array 3a, which is a first lens array, a planar optical waveguide 5a, which is a first optical waveguide member, and so on. Also, the second optical connection terminal 20 that is to be connected to the first optical connection terminal 10 includes a positioning member 1b, which is a second positioning member, a lens array 3b, which is a second lens array, an optical fiber array 5b, which is a second optical waveguide member, and so on.

In the present embodiment, light wave-guiding members such as the planar optical waveguide 5a and the optical fiber array 5b are collectively referred to as optical waveguide members. Also, in the descriptions hereafter, although optical connection between the optical connection terminals 10 and 20 will be described, connection between a pair of the optical connection terminals 10, or connection between a pair of the optical connection terminals 20 is also possible.

First, the optical connection terminal 10 will be described. A through hole is provided at a center of the positioning member 1a, and the lens array 3a is accommodated inside the through hole of the positioning member 1a and fixed with adhesive, for example. At this time, the lens array 3a is positioned at a predetermined position and fixed to the positioning member 1a. Here, the lens array 3a being positioned and fixed to the positioning member 1a means that the lens array 3a is positioned with high precision through dimensions and angles that can be confirmed visually or on a microscope monitor, for example. If the positioning member 1a and the lens array 3a are transparent, ultraviolet curable resin can be used as the adhesive.

The lens array 3a is optically connected to the planar optical waveguide 5a (an optical waveguide member). A plurality of optical waveguide paths are formed in the planar optical waveguide 5a, and lenses of the lens array 3a and the optical waveguide paths are aligned and optically connected, respectively. The lens array 3a and the planar optical waveguide 5a are fixed with adhesive, for example. Here, it is preferable that the planar optical waveguide 5a and the lens array 3a are made of silicon or glass and the positioning member 1a is made of thermoplastic resin. If the planar optical waveguide 5a and the lens array 3a are made of glass, an alignment state with high precision can be maintained with little deformation etc. thereof at high temperatures during reflow etc., for example. Meanwhile, making the positioning member 1a from resin facilitates processing of a guide mechanism 9a and so on.

Preferably, a shrinkage percentage of the positioning member 1a after being heated at 260° C. for one minute is 0.13% or less. More preferably, the shrinkage percentage of the positioning member 1a after being heated at 260° C. for one minute is 0.02% or less.

Such the positioning member 1a is manufactured as below, for example. Firstly, the positioning member 1a is molded by injection molding, for example, and then placed in a heating furnace for heat treatment at a temperature between 230° C. and 260° C. for one minute or more. For more stabilization, the heat treatment at the temperature between 230° C. and 260° C. for ten minutes or more is preferable.

Here, normally, the heat treatment (annealing) of thermoplastic resin generally aims for release etc. of inner stress at the time of molding and the like. Thus, in many cases, the heat treatment for non-crystalline resin is performed at a temperature that is slightly lower than a glass transition temperature Tg, and the heat treatment for crystalline resin is performed at a temperature that is slightly higher than the glass transition temperature. However, if the temperature is raised up to a melting point of the resin, the resin softens and a shape thereof cannot be maintained. Thus, for example, when taking PPS resin, which is a crystalline resin, as an example, the glass transition temperature thereof is approximately 90° C. and thus it is common to perform the heat treatment at a temperature around Tg+20-+30° C.

However, in the present embodiment, the heat treatment is performed for one minute or more at a temperature set between 230° C. and 260° C., which is far higher than the above temperature. For example, in regard to a melting point Tm=290° C. of PPS resin, a heat treatment condition is set at a temperature that is higher than (Tg+Tm)/2. Heating at a temperature that is impossible as the heat treatment condition of normal resin in this way can thermally shrink the resin with certainty. Note that the heat treatment temperature can be set according to a temperature in a scheduled reflow process.

In this way, compared to resin without the above heat treatment, an amount of shrinkage in the following reheating (the reflow process) can be reduced. Note that due to the shrinking through the heat treatment, pitches and hole diameters etc. of the guide mechanism are also to be reduced. So, it is preferable that dimensions thereof are made larger by shrinking margins in advance such that respective parts have the desired dimensions after the shrinking.

Preferably, difference in linear expansion coefficients (CTE) between the lens array 3a and the planar optical waveguide 5a is 200 ppm/° C. or less, or more preferably 10 ppm/° C. or less. This can prevent misalignment of optical axes at the time of temperature change and breakage at the time of reflow.

For such combination, quartz (CTE=0.5 ppm/° C.), silicon (CTE=2.6 ppm/° C.), indium (InP) (CTE=4.6 ppm/° C.), TEMPAX (a product name) (CTE=3.25 ppm/° C.), and the like are applicable as the planar optical waveguide 5a, to which quartz (CTE=0.5 ppm/° C.), silicon (CTE=approximately 3 ppm/° C.), TEMPAX (a product name) (CTE=3.25 ppm/° C.), optical glass (CTE=4-16 ppm/° C.) and the like are applicable as the lens array 3, respectively.

A photonic integrated circuit 13 is optically connected to a rear of the planar optical waveguide 5a. The planar optical waveguide 5a and the photonic integrated circuit 13 are fixed to each other with adhesive, for example. The photonic integrated circuit 13 is a SiP chip, for example, and is connected to a substrate, which will be described below.

The guide mechanism 9a for positioning with a connection target is provided on a front surface of the positioning member 1a (a surface facing the connection target). As shown in FIG. 1B, the guide mechanism 9a is disposed on each side of the lens array 3a. In the illustrated example, a guide hole is formed on one side of the lens array 3a and a fitting protrusion is formed on the other side. That is, the guide mechanism 9a has a concave/convex structure that can be fitted with the connection target.

Also, a magnet 11a, which is to be a fixing portion with the connection target, is disposed on the front surface of the positioning member 1a (the surface facing the connection target). As shown in FIG. 2A, a plurality of the magnets 11a are disposed at proximities of four corners of the positioning member 1a, respectively.

Next, the optical connection terminal 20 will be described. The optical connection terminal 20 has a structure that is substantially similar to that of the optical connection terminal 10. The lens array 3b is accommodated inside the positioning member 1b and fixed. At this time, the lens array 3b is positioned at a predetermined position and fixed with adhesive, for example, to the positioning member 1b. If the positioning member 1b and the lens array 3b are transparent, ultraviolet curable resin can be used as the adhesive.

The lens array 3b is optically connected to the optical fiber array 5b (an optical waveguide member). The optical fiber array 5b includes a plurality of optical fibers that are arranged side by side at predetermined intervals by means of a holding member having holes or V-shaped grooves. Each lens of the lens array 3b is aligned with and optically connected to each of the optical fibers. The lens array 3b and the optical fiber array 5b are fixed with adhesive, for example. It is preferable that the optical fiber array 5b and the lens array 3b are made of glass and the positioning member 1b is made of thermoplastic resin. In such the case, similar materials used for the positioning member 1a, the lens array 3a, and the planar optical waveguide 5a in the optical connection terminal 10 can be selected as materials for the positioning member 1b, the optical fiber array 5b, and the lens array 3b, respectively.

A guide mechanism 9b for positioning with a connection target is provided on a front surface of the positioning member 1b (a surface facing the connection target). As shown in FIG. 1B, the guide mechanism 9b is disposed on each side of the lens array 3b. In the illustrated example, a guide hole is formed on one side of the lens array 3b and a fitting protrusion is formed on the other side. That is, similarly to the guide mechanism 9a, the guide mechanism 9b has a concave/convex structure that can be fitted with the connection target. At this time, as shown in FIG. 3B, when the positioning members 1a and 1b are disposed facing each other, the fitting holes and the fitting protrusions of each other are disposed to face each other.

Also, a magnet 11b, which is to be a fixing portion with the connection target, is disposed on the front surface of the positioning member 1b (the surface facing the connection target). As shown in FIG. 2B, similarly to the positioning member 1a, a plurality of the magnets 11b are disposed in proximities of four corners of the positioning member 1b, respectively. Note that magnetic directions are set such that the magnets 11a and 11b attract each other when the positioning members 1a and 1b are disposed facing each other.

FIG. 4 is a cross-sectional view taken along Z-Z line in FIG. 3A, and is a cross-sectional view of a connection structure for optical connection terminals 30 at the magnets 11a and 11b. As shown in the drawing, the magnets 11a and 11b are disposed being slightly shifted backward from the facing surfaces of the positioning members 1a and 1b (toward an opposite side of the facing direction). That is, when the facing surfaces of the positioning members 1a and 1b come into contact with each other to be connected, there are gaps formed between end surfaces (facing surfaces) of the magnets 11a and 11b. As a way to fix the end surfaces of the magnets 11a and 11b shifted backward from the end surfaces of the positioning members 1a and 1b, a level difference may be formed such that diameters of fixing holes for the magnets 11a and 11b are reduced at the front, and the magnets 11a and 11b are inserted from the rear of the fixing holes until being butted against the level difference, for example.

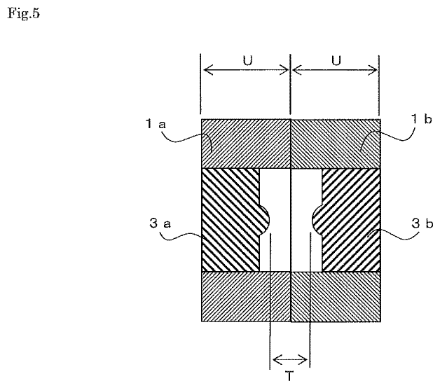

FIG. 5 is a view showing a positional relation between the lens array 3a and the lens array 3b in the connection structure for optical connection terminals 30 (FIG. 3A, FIG. 3B). As mentioned above, in the optical connection terminal 10, the planar optical waveguide 5a is optically connected to the lens array 3a that is fixed to the positioning member 1a. Also, in the optical connection terminal 20, the optical fiber array 5b is optically connected to the lens array 3b that is fixed to the positioning member 1b. When being positioned and connected to each other by the positioning members 1a and 1b, the lens array 3a and the lens array 3b do not come into contact with each other and there is a predetermined gap formed. That is, a space is formed at an optically connected part between the lens array 3a and the lens array 3b.

Since the lens array 3a and the lens array 3b do not come into contact with each other and the space is formed at the optically connected part in this way, a distance between the lenses can be optimally maintained (substantially twice a front focal length of the lenses), and this can minimize loss caused by defocusing at the time of optical connection. At this time, as mentioned above, by making sure that the magnets 11a and 11b are not in contact with each other and the facing surfaces of the positioning members 1a and 1b are in contact with each other, it is possible to improve the precision of the distance between the lens arrays.

A beam expansion diameter by the lens array 3a is preferably between 30 μm and 120 μm, or more preferably between 40 μm and 80 μm. Making the beam expansion diameter by the lens array 3a 30 μm or more, or even 40 μm or more, can increase an offset of tolerated optical axes. Also, making the beam expansion diameter by the lens array 3a 120 μm or less, or even 80 μm or less, can reduce loss due to tiling of the optical axes, which enables high-density packaging.

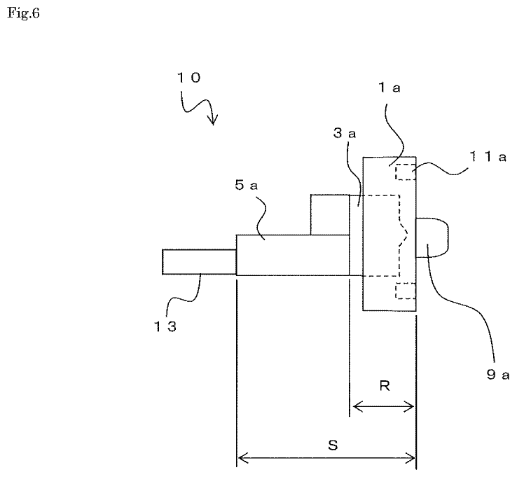

FIG. 6 is a side view of the optical connection terminal 10. As mentioned above, making the beam diameter equal to or less than a predetermined value can shorten a length of the optically connected part in an optical axis direction. For example, as shown in FIG. 6, a distance between a rear end surface of the lens array 3a and a front end surface of the positioning member 1a (R in the drawing) can be 1.7 mm or less, or even 1.2 mm or less. Also, a distance between a rear end surface of the planar optical waveguide 5a and the front end surface of the positioning member 1a (S in the drawing) can be 12 mm or less, or even 7 mm or less.

Similarly to the optical connection terminal 10, a beam expansion diameter by the lens array 3b is preferably between 30 μm and 120 μm, or more preferably between 40 μm and 80 μm. Also, a distance between a rear end surface of the lens array 3b and a front end surface of the positioning member 1b is preferably 1.7 mm or less, or even 1.2 mm or less.

For example, if an ideal beam expansion diameter is 60 μm, a distance between the lens arrays 3a and 3b (T in the drawing) is preferably between approximately 600 μm and approximately 700 μm (approximately twice the focal length of the lens). To make sure to obtain such a distance between the lenses, it is preferable that a thickness of the positioning members 1a and 1b (U in the drawing) is approximately 0.6 mm. The distance between the lenses and the thickness of the positioning members 1a and 1b will be described in detail below.

Also, as shown in FIG. 5, since the lens array 3a and the lens array 3b are optically connected without being in contact with each other, a little force is required for attachment/detachment at the time of connection and a mechanism for holding the each other's positioning members is unnecessary.

For example, normally, to have a physical contact for an optically connected part, a mechanism for constantly applying pressing force of 10 to 30 N is required, and since force larger than that is required at the time of attachment/detachment, a strong holding mechanism is to be required. In contrast, in the above-mentioned connection structure for optical connection terminals 30, such the force or the holding structure are unnecessary at the optical connected part. In addition, beams are expanded by the lens array 3a and the lens array 3b, thereby increasing a tolerance with the facing optical connection terminal.

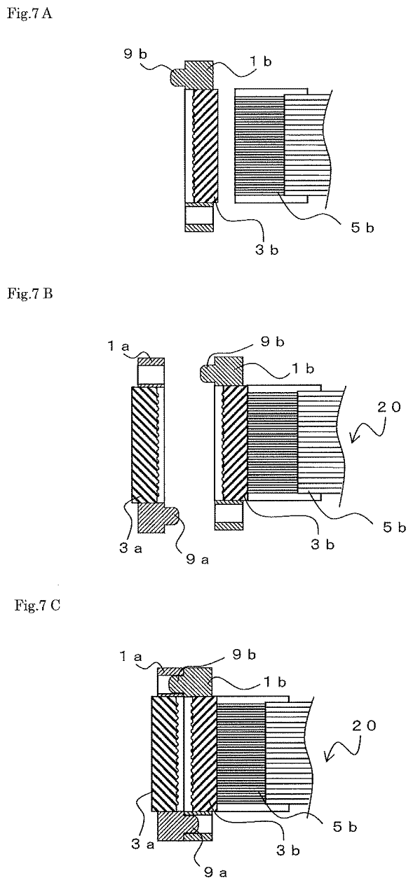

Next, a method for assembling the optical connection terminals 10 and 20 will be described. Firstly, as shown in FIG. 7A, the lens array 3b is fixed to the positioning member 1b. Also, the optical fiber array 5b is disposed with respect to the lens array 3b, and the lens array 3b and each optical fiber are aligned and fixed with adhesive.

Similarly, as shown in FIG. 7B, the lens array 3a is fixed to the positioning member 1a. In such the state, as shown in FIG. 7C, the positioning member 1a and 1b are connected. As mentioned above, the positioning members 1a and 1b are positioned by the guide mechanisms 9a and 9b, and thus mutual positions of the lens arrays 3a and 3b are determined, which makes the optical connection possible. A clearance between the guide hole and the guide protrusion configuring the guide mechanism 9a and 9b is preferably at least 1 μm or more. This can reduce resistance at the time of connecting the positioning members 1a and 1b. On the other hand, since the beams are expanded by the lenses, an increase in loss due to misalignment can be suppressed.

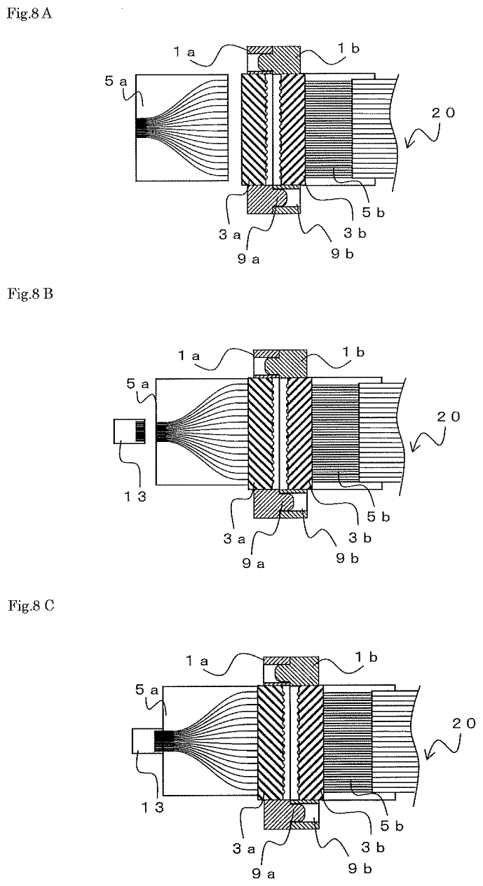

Next, as shown in FIG. 8A, the planar optical waveguide 5a is disposed at the rear of the lens array 3a, and the lens array 3a and the planar optical waveguide 5a are aligned.

As shown in FIG. 8B, when alignment of the lens array 3a and the planar optical waveguide 5a is completed, the lens array 3a and the planar optical waveguide 5a are fixed with adhesive. Next, as shown in FIG. 8C, the photonic integrated circuit 13 is disposed at the rear of the planar optical waveguide 5a, and the planar optical waveguide 5a and the photonic integrated circuit 13 are aligned and fixed. In this way, the assembly of the optical connection terminals 10 and 20 is completed.

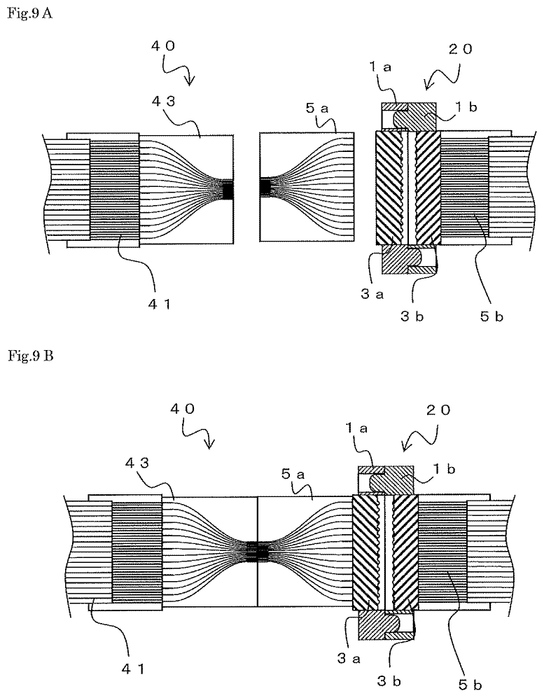

Note that another method may be used for alignment between the planar optical waveguide 5a and the lens array 3a. For example, as shown in FIG. 9A, an assembly for alignment connection 40 may be used. The assembly for alignment connection 40 has a structure in which an optical fiber array 41 and a planar optical waveguide 43 are aligned and optically connected in advance. The planar optical waveguide 43 has the same form as the planar optical waveguide 5a, for example.

As shown in FIG. 9B, the optical connection terminal 20 and the assembly for alignment connection 40 are disposed with the planar optical waveguide 5a in between, and then the planar optical waveguide 5a is aligned. As above, ways to perform the alignment of each part and the assembly operation procedure are not particularly limited.

For example, the following assembly method may be used. That is, the positioning member 1a and the lens array 3a are fixed, and at the same time the positioning member 1b and the lens array 3b are fixed, and then the positioning member 1a and the positioning member 1b are connected. With such a connected pair of the positioning member 1a and the lens array 3a and a connected pair of the positioning member 1b and the lens array 3b therebetween, the planar optical waveguide 5a and the optical fiber array 5b are disposed facing each other. Then, alignment of the planar optical waveguide 5a and the lens array 3a and alignment of the optical fiber array 5b and the lens array 3b are performed simultaneously and fixed with adhesive. By using such the method, the connection structure according to the present embodiment can be manufactured similarly to the above-mentioned assembly method.

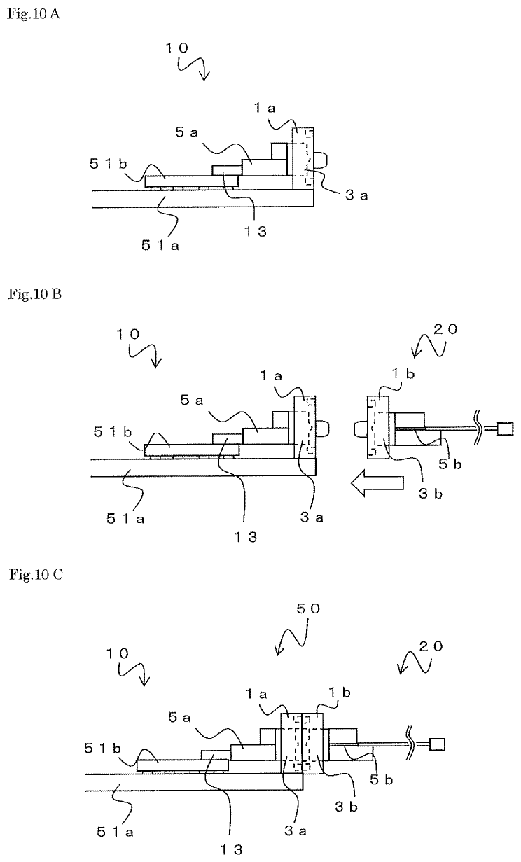

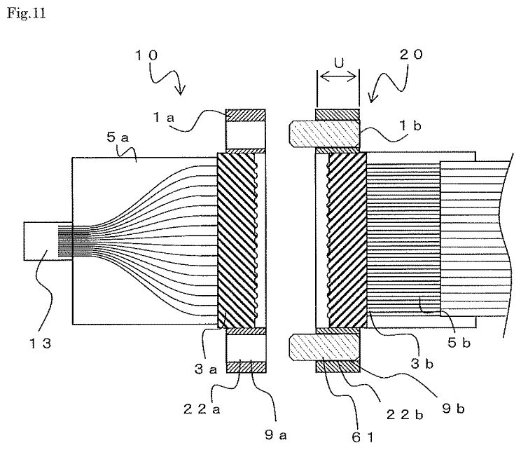

Next, a method for manufacturing an optical device using the connection structure for optical connection terminals 30 in which the optical connection terminals 10 and 20 are connected will be described. Firstly, the optical connection terminal 10 is detached from the optical connection terminal 20 and disposed on a substrate 51a and a substrate 51b, which are electronic circuit substrates, as shown in FIG. 10A. The substrate 51b (a chiplet substrate) is a substrate to be connected to the substrate 51a, and is connected to the photonic integrated circuit 13. Although only one each of the substrate 51b and the optical connection terminal 10 are disposed on the substrate 51a in the illustrated example, a plurality of the substrates 51b and the plurality of the optical connection terminals 10 are disposed on predetermined positions of the substrate 51a.

Next, parts are connected to each other through the reflow process. For example, through the reflow process performed in a state in which the optical connection terminal 10 is disposed on the substrate 51a and the substrate 51b, the substrate 51a and the substrate 51b are connected and the substrate 51b and the photonic integrated circuit 13 are connected.

After the reflow process, as shown in FIG. 10B and FIG. 10C, the optical connection terminals 20 are connected to the respective optical connection terminals 10. In this way, an optical device 50 in which a plurality of optical fibers with connectors attached are connected to an electronic circuit substrate can be manufactured. As mentioned above, no force is required for connecting the optical connection terminal 10 and the optical connection terminal 20, and the optical connection terminal 10 and the optical connection terminal 20 can be connected easily, with the magnets 11a and 11b, in a state in which the positioning members 1a and 1b determine each other's positions. In addition, the optical fibers and connectors are not connected to the substrate during the reflow process, and this facilitates handling.

As above, according to the present embodiment, with the glass-made lens arrays 3a and 3b and optical waveguide members (the planar optical waveguide 5a and optical fiber array 5b), the linear expansion coefficient difference can be kept small and a high-precision alignment state can be maintained even during the reflow. In particular, by keeping the linear expansion coefficient difference between the lens arrays 3a and 3b and optical waveguide members (the planar optical waveguide 5a and optical fiber array 5b) 20 ppm/° C. or less, the axial misalignment between the lens arrays and the optical waveguide members at the time of temperature change can be prevented with certainty. This can also contain dimension mismatch, which occurs due to thermal expansion at a high temperature (200° C. or more, for example) during the reflow process, within a tolerable range, and this can prevent breakage due to detachment or deformation of the fixing adhesive between the lens arrays and the optical waveguide members.

Also, by using the lens arrays 3a and 3b for optical connection, unlike optical connection terminals using normal physical contacts, pressing force exceeding a predetermined level is not required. Thus, only a small force is required at the time of connection, and no mechanism for maintaining the pressing force is required. In addition, beams are expanded by using the lens arrays 3a and 3b, thereby increasing the tolerance of the facing optical connection terminals.

Also, by making the positioning members 1a and 1b from resin, the guide mechanisms 9a and 9b can be processed with high precision, which can improve alignment precision. In particular, by disposing the guide mechanism 9a and 9b on both sides of the lens arrays 3a and 3b, respectively, the positioning can be performed with high precision similarly as a conventional MT ferrule. Also, by disposing the magnets 11a and 11b on the front surfaces of the positioning members 1a and 1b, the optical connection terminals 10 and 20 can be connected with a little force.

By using such the connection structure for optical connection terminals 30, the optical connection terminals 10 are connected to the substrates 51 and 51b by reflow and then the optical connection terminals 20 are connected to the respective optical connection terminals 10. In this way, the optical device 50 can be efficiently assembled. At this time, in the reflow process, the optical connection terminals 20 having optical fibers are not yet connected, and thus workability is good and reflow resistance of the optical fibers and the connectors is unnecessary.

In the present embodiment, although each of the optical waveguide members are optically connected via the lens arrays 3a and 3b, the lens arrays 3a and 3b may not be used. For example, the planar optical waveguide 5a can be directly fixed to the positioning member 1a. Also, the optical fiber array 5b can be directly fixed to the positioning member 1b. In such the case, the planar optical waveguide 5a is optically connected to the optical fiber array 5b directly.

Next, another embodiment will be described. In the descriptions hereinafter, the same notations as in FIG. 1 to FIG. 10C will be given to structures having the same functions as in the above-mentioned embodiment, and redundant explanations will be omitted.

FIG. 11 is a view showing the optical connection terminals 10 and 20 according to a second embodiment. In an example shown in FIG. 11, structures of the guide mechanism 9a and 9b are different from those in the above-mentioned embodiment. In the example shown in FIG. 11, each of the positioning members 1a and 1b includes guide holes being formed. For example, a guide pin 61 is inserted into and fixed to a male-side hole 22b, which is the guide mechanism 9b of the one positioning member 1b, and the guide mechanism 9a of the other positioning member 1b is a female-side hole 22a into which the guide pin 61 can be inserted and/or removed. Note that the male-side hole 22b and the female-side hole 22a may be reversed and the guide pin 61 may be fixed to the side of the positioning member 1a, for example.

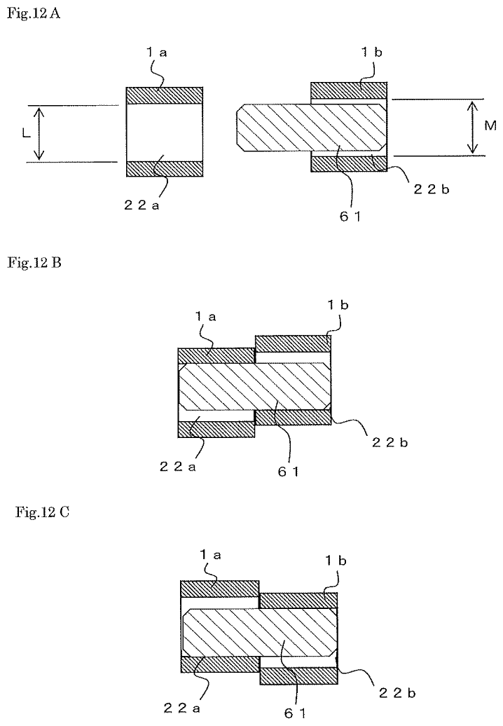

Here, as shown in FIG. 12A, a diameter of the male-side hole 22b (M in the drawing) to which the guide pin 61 is fixed may be equal to a diameter of the female-side hole 22a (L in the drawing) into which a tip end of the guide pin 61 is to be inserted at the time of connection. However, the diameter of the female-side hole may be made larger than that of the male-side hole. For example, as shown in FIG. 12B and FIG. 12C, if the diameters of both the holes are the same, a range of maximum position misalignment between the positioning member 1a and the positioning member 1b may become large.

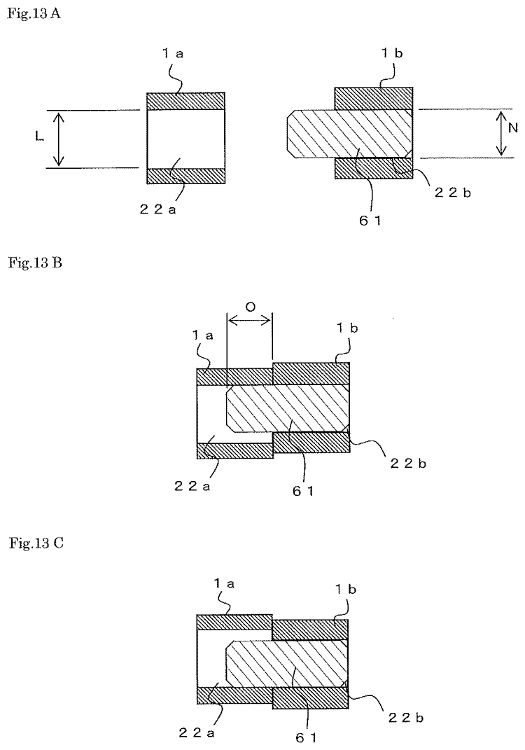

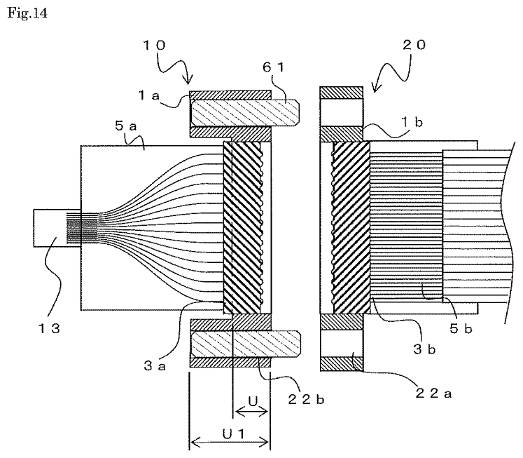

In contrast, in an example shown in FIG. 13A, the view shows an example in which the diameter of the male-side hole into which the guide pin 61 is to be inserted is made smaller, and FIG. 13B and FIG. 13C are views corresponding to FIG. 12B and FIG. 12C in such the case. In the present embodiment, the diameter of the female-side hole 22a (L in the drawing) into which the tip end of the guide pin 61 is to be inserted at the time of connection is larger than the diameter of the male-side hole 22b (N in the drawing) to which the guide pin 61 is fixed. Compared to the case in which the diameters of both the holes are the same, this can reduce an amount of position misalignment between the positioning member 1a and the positioning member 1b. Even in such the case, the size of the female-side hole 22a is larger than that of the guide pin 61 and this can make insertion resistance small.

It is preferable that the diameter of the male-side hole 22b is equal to or less than an outer diameter of the guide pin 61. For example, it is preferable that the diameter of the male-side hole 22b is smaller than an outer diameter of the guide pin 61 by 0.5 μm or more. That is, the guide pin 61 is preferably pressed and fitted into the male-side hole 22b.

It is also preferable that the diameter of the female-side hole 22a is larger than the outer diameter of the guide pin 61, and also the diameter of the female-side hole 22a is larger than the diameter of the male-side hole 22b by 1 μm or more. In this way, when the positioning member 1a and the positioning member 1b are connected, the guide pin 61 is inserted into the female-side hole 22a, and mutual positioning with high precision can be performed.

Also, an insertion length of the guide pin 61 (O in FIG. 13B) with respect to the female-side hole is preferably 1 mm or less, or more preferably 0.6 mm or less. By shortening the insertion length of the guide pin 61 in this way, friction between the guide pin 61 and the female-side hole can be reduced, tolerating some play, thereby facilitating the insertion. Note that, to perform positioning between the positioning member 1a and the positioning member 1b, the insertion length of the guide pin 61 is preferably 0.2 mm or more.

On the other hand, the maximum insertion length of the guide pin 61 into the male-side hole 22b is equal to a thickness of the positioning member 11b (U in FIG. 11). At this time, if a fixing length of the guide pin 61 is short, tilting or the like of the guide pin 61 may occur. For this reason, it is preferable that the fixing length of the guide pin 61 to the male-side hole 22b (the insertion length of the guide pin 61 in the male-side hole 22b) is 1.5 mm or more.

On the other hand, if an overall thickness of the positioning member is 1.5 mm or more, the connection structure becomes large in size. Thus, it is preferable to increase only the fixing length of the guide pin 61 without changing the thickness of the positioning member.

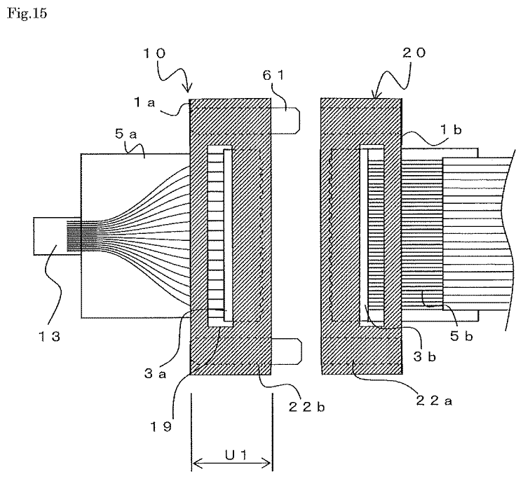

FIG. 14 is a view showing the positioning member in which the fixing length of the guide pin 61 is extended. In the drawings hereafter, contrariwise to the one in FIG. 11, an example in which the male-side hole 22b is formed in the positioning member 1a to fix the guide pin 61 and the female-side hole 22a is formed in the positioning member 11b will be described. However, the guide pin 61 may be fixed to either of the positioning members 1a and 1b.

In the example shown in FIG. 14, proximity of the male-side hole 22b of the positioning member 1a is formed so as to be protruding backward. That is, although a thickness of the positioning member 1a at a part for fixing the lens array 3a has a thickness U similarly as in FIG. 11 etc. mentioned above, the thickness of the positioning member 1a in the male-side hole 22b is U1, which is larger than U. This can make a connection interface between the lens array 3a and the planar optical waveguide 5a visible. This facilitates alignment and connection operation between the lens array 3a and the planar optical waveguide 5a.

Also, since a depth of the male-side hole 22b can be set to U1, it is possible to make the fixing length of the guide pin 61 larger than the thickness U of the positioning member 1a. Thus, the fixed length of the guide pin 61 can be 1.5 mm or more. In such the case, the positioning member 1b may have the similar shape as the positioning member 1a.

Also, FIG. 15 is a view showing another embodiment with respect to FIG. 14. In an example shown in FIG. 15, while the thickness of each of the positioning members 1a and 1b is U1, a window 19 is formed at proximity of a fixing part of each of the lens arrays 3a and 3b. The window 19 may penetrate the positioning member 1a or may be opened only on one side surface of the lens array 3a.

With the positioning members 1a and 1b shown in FIG. 15, the depth of the male-side hole 22b can be set to U1 and thus it is possible to have the sufficient fixing length of the guide pin 61. Also, a joint part between the lens array 3a and the planar optical waveguide 5a is exposed to the outside by the window 19, and this facilitates the alignment and connection operation between the lens array 3a and the planar optical waveguide 5a.

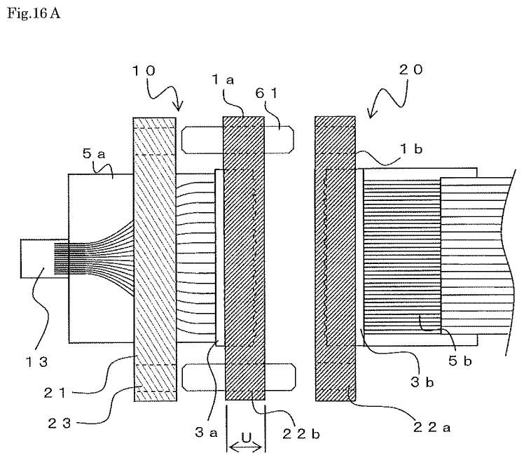

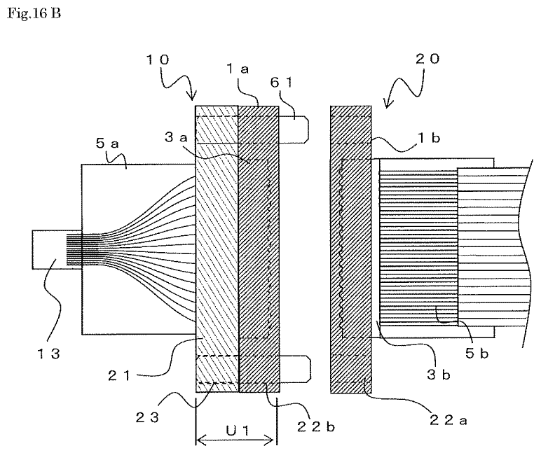

Also, FIG. 16A is a view showing another embodiment with respect to FIG. 14. In an example shown in FIG. 16A, the positioning member 1a having the thickness U is used. In addition, a guide-pin holding member 21 is disposed at the rear of the positioning member 1a. In the guide-pin holding member 21, a hole 23 is formed at a position corresponding to the male-side hole 22b of the positioning member 1a. The male-side hole 22b and the hole 23 are formed to have substantially the same diameters.

After aligning and fixing the lens array 3a and the planar optical waveguide 5a, as shown in FIG. 16B, the guide-pin holding member 21 is brought to a close contact with the rear of the positioning member 1a so as to dispose the male-side hole 22b and the hole 23 on the same axis. In this way, the fixing length of the guide pin 61 can be set to a sum of depths of the male-side hole 22b and the hole 23. Thus, the sufficient fixing length of the guide pin 61 can be obtained.

Although the guide pin 61 is inserted into the positioning member 1a (the male-side hole 22b) in FIG. 16A, timing for insertion of the guide pin 61 is not limited to the illustrated example. For example, after closely contacting and disposing the guide-pin holding member 21 to the rear of the positioning member 1a, the guide pin 61 may be inserted into and fixed to the male-side hole 22b and the hole 23 at once.

As above, when the optical connection terminals 10 and 20 are connected, the guide pin 61 fixed to one of the positioning members is inserted into the guide hole of the other positioning member to perform the positioning. The guide mechanisms 9a and 9b of the positioning members 1a and 1b may have unlimited shapes of a concave/convex structure (a fitting structure) that allows positioning.

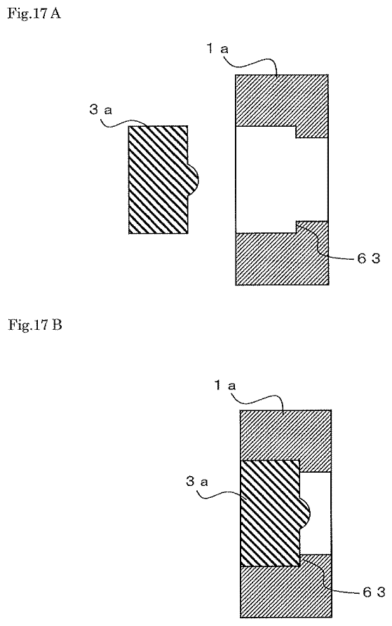

Next, a third embodiment will be described. FIG. 17A is a view showing the positioning member 1a and the lens array 3a according to the third embodiment. Note that, hereafter, only the optical connection terminal 10 will be described and descriptions for the optical connection terminal 20 will be omitted. However, the present embodiment will be applicable naturally to the optical connection terminal 20.

The present embodiment is different from the above-mentioned embodiment position in that a positioning part 63 is formed inside the positioning member 1a. The positioning part 63 is a level difference part formed such that a size of a hole decreases from a rear side toward a front side thereof. As shown in FIG. 17B, when the lens array 3a is inserted from the rear of the positioning member 1a, a flat portion of a front surface of the lens array 3a comes into surface contact with the positioning part 63. That is, the positioning part 63 has a surface that is perpendicular to an insertion direction of the lens array 3a.

By forming in the positioning member 1b the positioning part 63 to which the front surface of the lens array 3a can be in surface contact in this way, the position of the lens array 3a can be accurately regulated with respect to the positioning member 1a.

Providing in the positioning members 1a and 1b the positioning parts 63 to which the front surfaces of the lens arrays 3a and 3b can be in surface contact in this way can make the respective distances between the tip ends of the lens arrays 3a and 3b and the front surfaces of the positioning members 1a and 1b constant. Thus, in the optical connection terminals 10 and 20, which are each other's connection targets facing each other, a distance between the lens array 3a and the lens array 3b can be optimally maintained, approximately twice a focal length, for example, and this can suppress an increase in loss caused by defocusing.

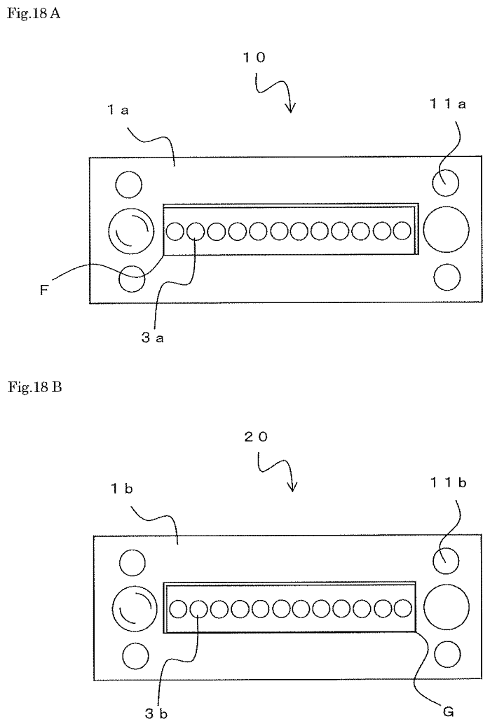

Also, as shown in FIG. 18A, the lens array 3a may be inserted into the positioning member 1a and fixed after positioning a corner of the lens array 3a to a corner of a hole of the positioning member 1a (F in the drawing). In this way, the positioning member 1a and the lens array 3a can be positioned. That is, by pressing and fixing two outer surfaces of the substantially rectangular lens array 3a against at least two inner surfaces of the hole of the substantially rectangular positioning member 1a, the positioning member 1a can be positioned to the lens array 3a.

Similarly, as shown in FIG. 18B, the lens array 3b may be inserted into the positioning member 1b and fixed after positioning a corner of the lens array 3b to a corner of a hole of the positioning member 1b (G in the drawing). In this way, the positioning member 1b can be positioned to the lens array 3b. That is, by pressing and fixing two outer surfaces of the substantially rectangular lens array 3b against at least two inner surfaces of the hole of the substantially rectangular positioning member 1b, the positioning member 1b can be positioned to the lens array 3b. Thus, by positioning the lens arrays 3a and 3b to symmetric corner directions of the positioning members 1a and 1b, position misalignment between the lens arrays 3a and 3b at the time of connection can be suppressed.

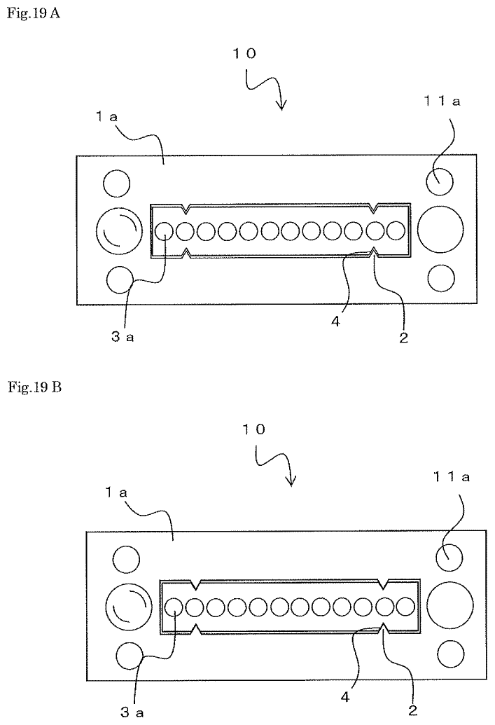

Also, as shown in FIG. 19A, a convex portion 2 may be provided on the inner surface of the hole of the positioning member 1a, and a concave portion 4 may be formed on the outer surface of the lens array 3a. Alternatively, the concave portion 4 may be provided on the inner surface of the hole of the positioning member 1a, and the convex portion 2 may be formed on the outer surface of the lens array 3a. That is, by forming concave and convex shapes corresponding to each other on the inner surface of the positioning member 1a and the outer surface of the lens array 3a, the concave/convex shapes on the inner surface of the positioning member 1a can be fitted with the concave/convex shapes on the outer surface of the lens array 3a. Thus, the lens array 3a can be positioned and fixed to the positioning member 1a with high precision.

Also, as shown in FIG. 19B, the convex portion 2 may be formed slightly larger in size than the concave portion 4. In such the case, the resin-made positioning member 1a can elastically deform with respect to the glass-made lens array 3. In this way, the concave/convex shapes on the inner surface of the positioning member 1a can be fitted with the concave/convex shapes on the outer surface of the lens array 3a to be fixed to each other while being closely in contact with each other. That is, when the lens array 3a is pushed into the positioning member 1a, the concave/convex shapes on the inner surface of the positioning member 1a may elastically deform and the lens array 3a may be pressed and fit into the positioning member 1a and fixed. The embodiments in FIG. 19A and FIG. 19B are also similarly applicable to the optical connection terminal 20.

Also, as shown in FIG. 20A, a positioning protrusion 6 may be formed on the front surface of the lens array 3a. In such the case, a positioning hole 8 is formed in the positioning member 1a separately from the guide mechanism 9a.

As shown in FIG. 20B, by inserting the positioning protrusion 6 of the lens array 3a into the positioning hole 8 of the positioning member 1a, the lens array 3a can be positioned and fixed to the positioning member 1a. A diameter of the positioning protrusion 6 (I in the drawing) is slightly smaller than a diameter of the positioning hole 8 (H in the drawing). The embodiments in FIG. 20A and FIG. 20B are also similarly applicable to the optical connection terminal 20.

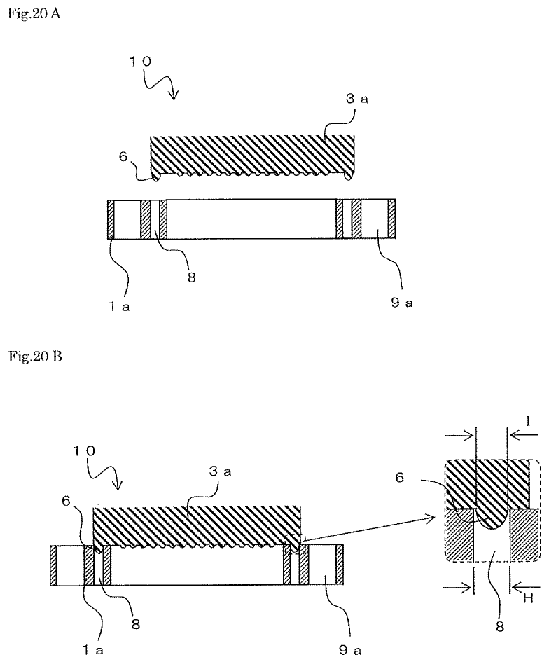

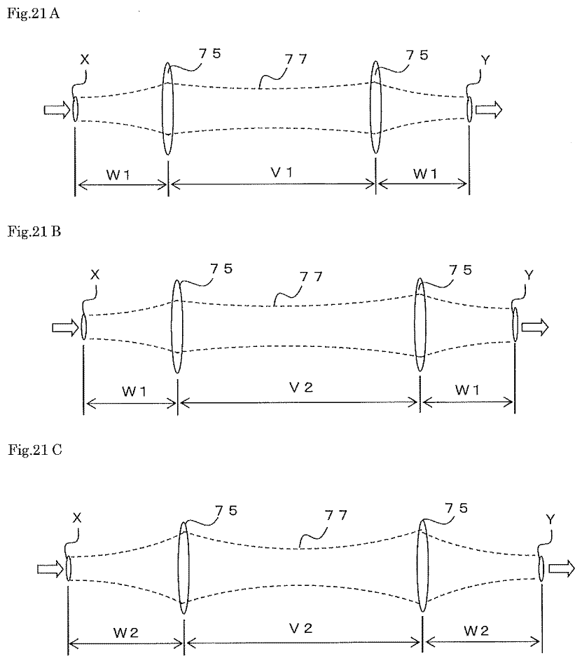

Disposing the lens arrays 3a and 3b to the positioning members 1a and 1b, respectively, with high precision in this way can improve the precision of the distance between the lens arrays (T in FIG. 5). Here, FIG. 21A is a schematic view showing a state in which a beam 77 propagates from a light emission part (X in the drawing) to a light incidence part (Y in the drawing) via a pair of lenses 75. The beam 77 emitted from the light emission part X enters the lens 75 with a gradually increasing diameter thereof to be substantially parallel light (strictly speaking, not parallel but slightly constricted in the middle), and then the beam 77 enters the opposing lens 75, which narrows down the beam diameter toward the light incidence part Y.

Here, it is ideal that a distance W1 between the light emission part X and the lens 75 and a distance W1 between the lens 75 and the light incidence part Y are equal to a back focal length of the lens 75 and that a distance V1 between the lenses 75 is equal to a twice a front focal length of the lens 75. In such the case, in theory, the beam diameter at the light emission part X is equal to the beam diameter at the light incidence part Y, and loss due to optical connection can be minimized.

Here, as mentioned above, if the ideal beam diameter is 60 μm, it is preferable that the distance of the lens 75 (V1 in the drawing) is approximately 600 μm-700 μm. If such a positional relation is described using FIG. 4, a distance T between the lens arrays 3a and 3b is to be 600 μm-700 μm.

To obtain such the distance T, the thickness U of the positioning members 1a and 1b is to be approximately 0.6 mm. However, manufacturing or handling of the positioning members 1a and 1b having the thickness of 0.6 mm is difficult. Thus, when handling performance and manufacturability are taken into consideration, the positioning members 1a and 1b preferably have the thickness of 0.8 mm or more, or more preferably have the thickness of 1 mm or more. On the other hand, if the thickness of the positioning members 1a and 1b is approximately 1 mm or more, the distance T between the lens arrays 3a and 3b is to be approximately 1500 μm.

FIG. 21B is a schematic view showing such the state, in which the distance between the lenses is V2, which is larger than V1 with respect to FIG. 21A. In such the case, the beam 77 from the light emitting part X is expanded between the lenses 75, and, as a result, the beam diameter at the light incidence part Y becomes larger. That is, the beam is out of focus at the light incidence part Y.

So, in the present embodiment, as shown in FIG. 21C, the distances from the light emission part X and the light incident part Y to the lens 75 are changed, respectively, so as to be distances W2, which are larger than the back focal length W1 of the lens 75. By disposing the emission part X and the light incident part Y to be shifted backward (in a direction in which the distance from the lens 75 increases) from the back focal length of the lens 75 in this way, the beam diameter from the light emission part X can be made substantially the same as the beam diameter at the light incident part Y.

FIG. 22 is a schematic view showing an arrangement of each part in such the state. A distance of the lens arrays 3a and 3b, which are disposed facing each other after being positioned by the positioning members 1a and 1b, is the distance V2 (approximately 600-700 μm, for example), which is larger than twice the front focal length of the lens arrays 3a and 3b (approximately 1500 μm, for example). At this time, the distance W2 from the rear surface of the lens array 3a to the front end of the planar optical waveguide 5a is set to be larger than the back focal length W1 of the lens array 3a. Similarly, the distance W2 from the rear surface of the lens array 3b to the front end of the optical fiber array 5b is set to be larger than the back focal length W1 of the lens array 3b.

In more detail, it is preferable that a position of the front surface of each optical waveguide member is moved back from the back focal point position of the lens arrays 3a and 3b (the position at the distance W1) by 5 μm or more (W2≥W1+0.5 μm). More preferably, the position of the front surface of each optical waveguide member is moved back from the back focal point position of the lens arrays 3a and 3b by 10 μm or more (W2≥W1+10 μm). In this way, even if the thickness of the positioning members 1a and 1b is increased, the beam entering and exiting an angular optical waveguide member can be focused.

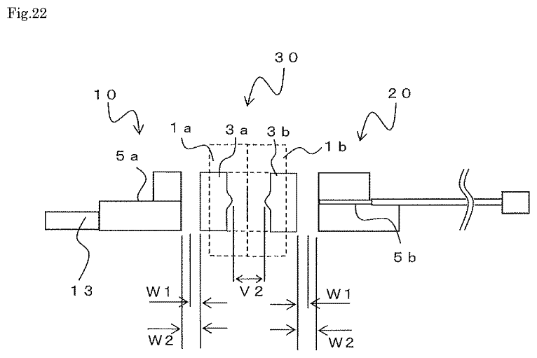

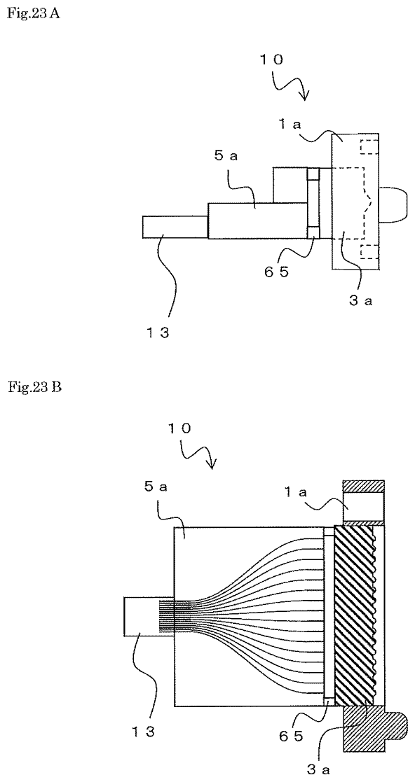

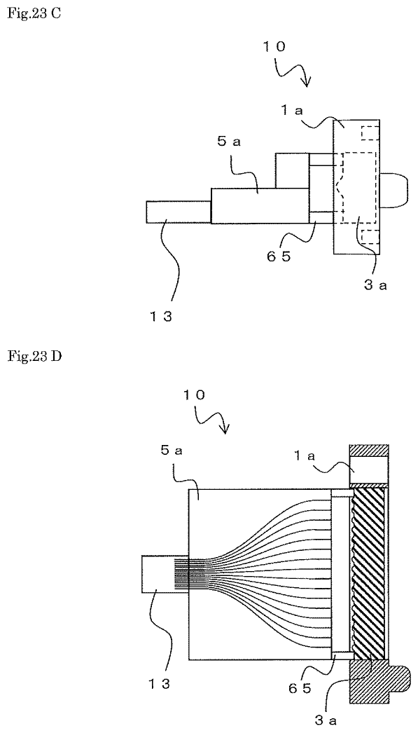

Next, a fourth embodiment will be described. FIG. 23A and FIG. 23B are views showing the optical connection terminal 10 according to the fourth embodiment, and FIG. 23A is a side view and FIG. 23B is a cross-sectional view. In the present embodiment, as mentioned above, to maintain the distance between the lens array and the optical waveguide member, a spacer 65 is disposed between the lens array 3a and the planar optical waveguide 5a, for example, and a gap is formed between the lens array 3a and the planar optical waveguide 5a.

The spacer 65 is to be disposed at parts other than optical paths, and a shape and arrangement thereof are not particularly limited. For example, the spacer 65 having a frame-like shape may be disposed on an outer periphery part of the positioning member 1a so as to surround the lens array 3a.

FIG. 23C and FIG. 23D are views showing another embodiment of the optical connection terminal 10, and FIG. 23C is a side view and FIG. 23D is a cross-sectional view. In the embodiment shown in FIG. 23C and FIG. 23D, the direction of the lens array 3a is opposite to that in FIG. 23A and FIG. 23B. In such the case, the convex lens portion can be brought closer to the planar optical waveguide 5a than in the case shown in FIG. 23A and FIG. 23B. This can solve a problem that the beam diameter spreads more than necessary when a spread angle of light emitted from the planar optical waveguide 5a is large, for example.

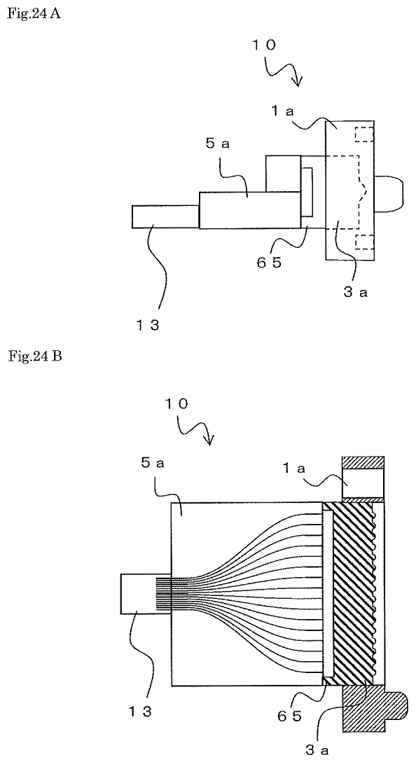

Also, FIG. 24A is a side view and FIG. 24B is a cross-sectional view showing another structure. In the illustrated example, similarly to FIG. 23A and FIG. 23B, the spacer 65 is disposed between the lens array 3a and the planar optical waveguide 5a, and a gap is formed between the lens array 3a and the planar optical waveguide 5a. However, in the illustrated example shown in FIG. 24A and FIG. 24B, the spacer 65 and the lens array 3a are configured integrally.

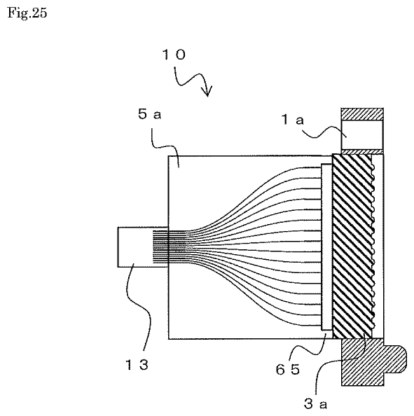

Also, in an example shown in FIG. 25, the spacer 65 and the planar optical waveguide 5a are configured integrally. Integrally forming the spacer 65 with the lens array or the optical waveguide member in this way reduces the number of components and facilitates the assembly operation. In the optical connection terminal 20, the spacer 65 may be disposed between the optical fiber array 5b and the lens array 3b. Also, in either of the embodiments, a thickness of the spacer 65 is preferably 5 μm or less.

According to the fourth embodiment, by providing a gap between the optical waveguide member and the lens array 3a or 3b, beams can be efficiently expanded by using such space (a refractive index). Even if the space is filled with a medium such as adhesive, parameters such as the beam diameter can be freely adjusted by using a refractive index of the medium. Also, as mentioned above, even if the distance between the lens arrays 3a and 3b is extended beyond twice the front focal length, loss in optical connection between the optical waveguide members can be suppressed.

Next, a fifth embodiment will be described. FIG. 26A is a view showing the optical connection terminal 10 according to the fifth embodiment. In the present embodiment, in a side view, an interface between the planar optical waveguide 5a and the lens array 3a is formed obliquely to an optical axis direction. That is, the interface between the lens array 3a and the planar optical waveguide 5a is not perpendicular to an optical axis of the planar optical waveguide 5a.

In an example shown in FIG. 26A, the optical axes of the planar optical waveguide 5a and the lens array 3a are provided on the same straight line and only the interface is formed obliquely. In contrast, as shown in FIG. 26B, the optical axis of the planar optical waveguide 5a and the optical axis of the lens array 3a may be connected at a predetermined angle.

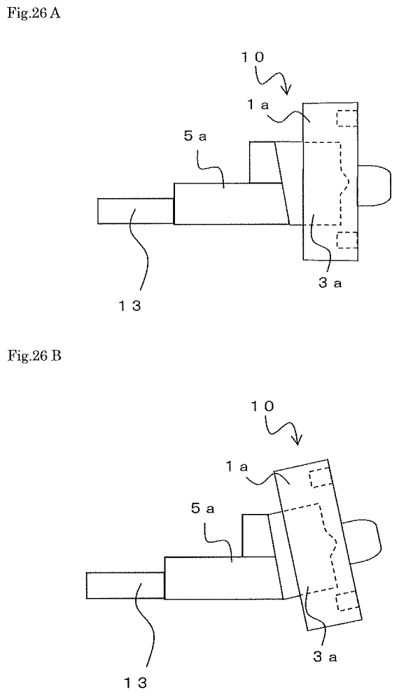

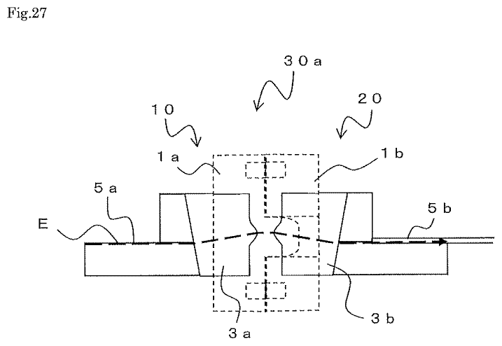

FIG. 27 is a view showing a connection structure for optical connection terminals 30a in which the optical connection terminal 10 of FIG. 26A and the optical connection terminal 20 of a similar shape are connected. That is, in a side view, the interface between the planar optical waveguide 5a and the lens array 3a is formed obliquely to the optical axis direction of the lens array 3a, and, at the same time, an interface between the optical fiber array 5b and the lens array 3b is formed obliquely to an optical axis direction of the lens array 3b. In such the case, when connected, the positioning member 1a and the positioning member 1b are connected such that the interface between the planar optical waveguide 5a and the lens array 3a and the interface between the optical fiber array 5b and the lens array 3b are substantially linearly symmetrical about a connected part as an axis of symmetry.

In this way, oblique emission and oblique incidence at each obliquely formed interface can be compensated.

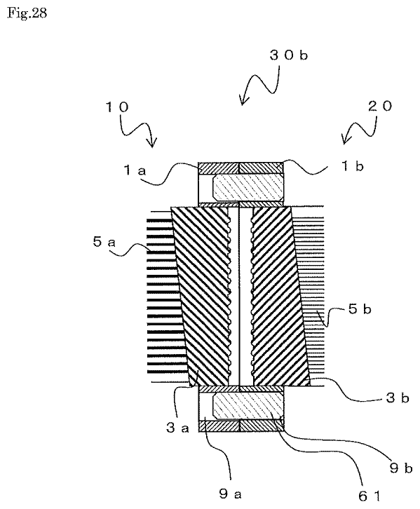

Also, FIG. 28 is a view showing a connection structure for optical connection terminals 30b in which the optical connection terminal 10, in which the interface between the planar optical waveguide 5a and the lens array 3a is formed obliquely, in a plan view, toward a side-by-side direction of the optical paths, is connected to the optical connection terminal 20 of a similar shape. That is, in a plan view, the interface between the planar optical waveguide 5a and the lens array 3a is formed obliquely to the optical axis direction of the lens array 3a, and, at the same time, the interface between the optical fiber array 5b and the lens array 3b is formed obliquely to the optical axis direction of the lens array 3b. In such the case, when connected, the positioning member 1a and the positioning member 1b are connected such that the interface between the planar optical waveguide 5a and the lens array 3a and the interface between the optical fiber array 5b and the lens array 3b are substantially parallel to each other.

This can make the distance of each of the optical paths arranged side by side (the sum of optical path lengths of the lens array 3a and the lens array 3b) substantially constant.

Also, FIG. 29 is a view showing a connection structure for optical connection terminals 30c in which the optical connection terminal 10, in which the optical paths of the planar optical waveguide 5a are formed obliquely to the interface with the lens array 3a, is connected to the optical connection terminal 20 of a similar shape. That is, in a plan view, the optical paths of the planar optical waveguide 5a are formed obliquely to the optical axis direction of the lens array 3a, and, at the same time, the optical paths of the optical fiber array 5b are formed obliquely to the optical axis direction of the lens array 3b. In such the case, when connected, the positioning member 1a and the positioning member 1b are connected such that the optical paths of the planar optical waveguide 5a and the optical paths of the optical fiber array 5b are substantially linearly symmetrical about a connected part as an axis of symmetry.

In this way, oblique emission and oblique incidence at each obliquely formed interface can be compensated.

According to the fifth embodiment, the interface between the optical waveguide member and the lens array is formed obliquely to the optical axis direction of the optical waveguide member, and this can reduce influence of reflected light at the interface. The similar effect can be obtained by providing an anti-reflection film on the interface between the optical waveguide member and the lens array.

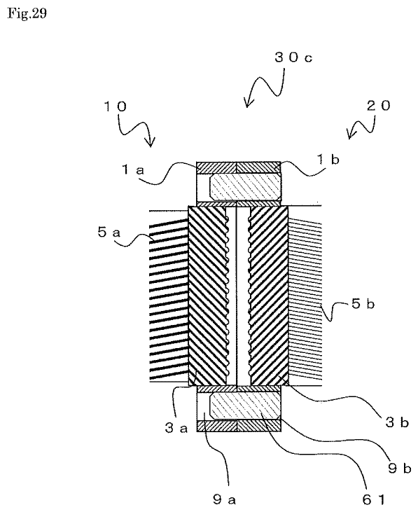

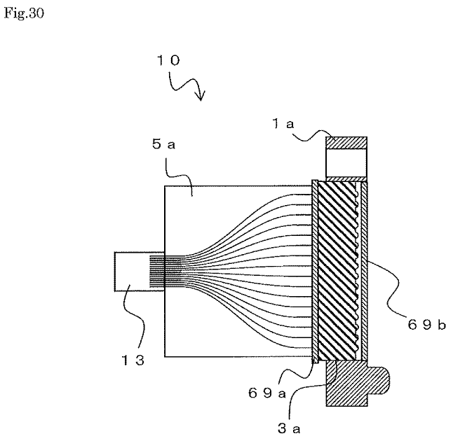

Also, as show in FIG. 30, functional elements such as isolators 69a and 69b may be disposed between the planar optical waveguide 5a and the lens array 3a or in front of the lens array 3a. Either one of the isolators 69a and 69b may be used. Further, the isolator may be disposed either between the optical fiber array 5b and the lens array 3b or in front of the lens array 3b.

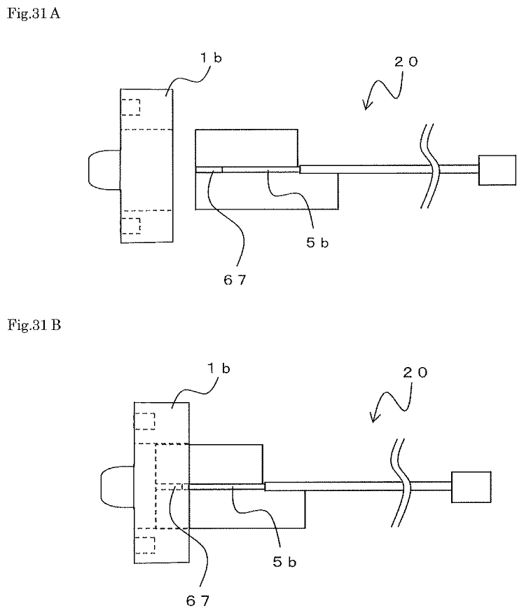

Next, a sixth embodiment will be described. FIG. 31A and FIG. 31B are views showing assembly steps of the optical connection terminal 20 according to the sixth embodiment. In the present embodiment, a GRIN fiber 67 is fusion connected to a tip end of the optical fiber array 5b. The GRIN fiber 67 is a graded index fiber and can expand the beam diameter relative to the optical fibers. Thus, in the present embodiment, no lens array is required. That is, the optical fiber array 5 and the GRIN fiber 67 (a holding member for holding the optical fibers etc.) are to be fixed to the positioning member 1b.

Such the optical connection terminal 20 may be connected not only to the optical connection terminal 10 but also to the other optical connection terminal 20. Even in such the case, when the one positioning member 1b is connected to the other positioning member 1b, the optical fiber arrays 5b (the GRIN fibers 67) are not in contact with each other and a space is formed at the optically connected part.

According to the sixth embodiment, the beam diameter can be expanded without using the lens array. This can expand tolerance between the facing optical connection terminals. Also, since there is no need to used adhesive for joining the optical fiber array 5 and the lens array 3b, optical power durability can be improved. Note that, in the case in which lens array is used, the GRIN lens array may be used as the lens array.

Next, a method for disposing each optical connection terminal on the substrate will be described. Although an entirety of the optical connection terminal 10 is disposed on the substrate 51a, the optical connection terminal 10 is connected to the substrate 51b on the substrate 51a, and the positioning member 1a is fixed to the substrate 51a in the above-mentioned example shown in FIG. 10, the embodiment is not limited thereto.

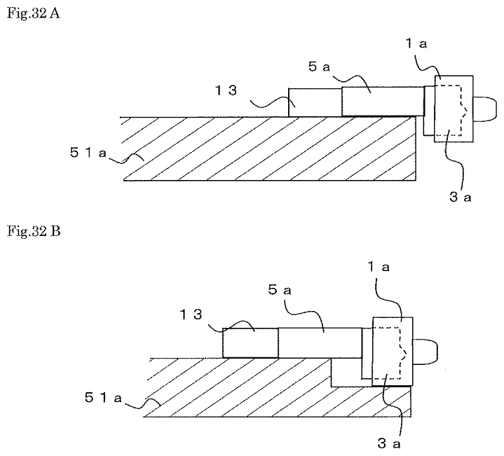

For example, in an example shown in FIG. 32A, the substrate 51b is not used and the optical connection terminal 10 is directly connected to the substrate 51a. Also, the lens array 3 and the positioning member 1a are disposed so as to protrude from an end part of the substrate 51a.

Also, in an example shown in FIG. 32B, a level difference is formed at the end part of the substrate 51a. The level difference is formed on an upper surface side of the substrate 51a, and a thickness of the substrate 51a on the end part side becomes thin. That is, the upper surface of the substrate 51a is positioned lower at the level difference part. The positioning member 1a is disposed at the part where the upper surface is lowered due to the level difference and fixed to the substrate 51a. By disposing the positioning member 1a to the substrate 51a as shown in FIG. 32A and FIG. 32B, an overall height can be reduced.

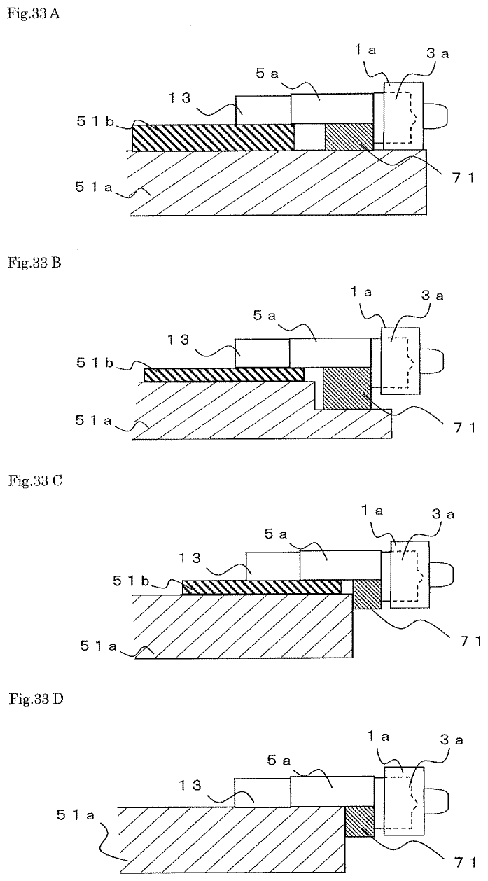

Also, an example shown in FIG. 33A is substantially similar to the one in FIG. 10A except that a glass 71 is disposed between the planar optical waveguide 5a and the substrate 51a. As mentioned above, the planar optical waveguide 5a is made of glass, and, by disposing the glass 71 having a close linear expansion coefficient between the planar optical waveguide 5a and the substrate 51a, stress applied to the planar optical waveguide 5a at the time of temperature change can be alleviated.

Similarly, in an example shown in FIG. 33B, a level difference is provided at the end part of the substrate 51a so that the upper surface position of the substrate 51a is lowered. The glass 71 is disposed on the part of which the thickness is reduced due to the level difference. The planar optical waveguide 5a is fixed to the substrate 51a via the glass 71.

Also, in an example shown in FIG. 33C, the positioning member 1a is disposed so as to completely hang out from the substrate 51a. The glass 71 is disposed on a side end surface of the substrate 51a, and the substrate 51a is fixed with the planar optical waveguide 5a or the lens array 3a via the glass 71.

Also, in an example shown in FIG. 33D, the substrate 51b is not used and the optical connection terminal is directly connected to the substrate 51a. Also, the positioning member 1a is disposed so as to completely hang out from the substrate 51a. The glass 71 is disposed on the side end surface of the substrate 51a, and the substrate 51a is fixed with the planar optical waveguide 5a or the lens array 3a via the glass 71. As shown in FIG. 33B to FIG. 33D, by connecting the substrate 51a with the planar optical waveguide 5a or the lens array 3a via the glass 71, similar effects as in FIG. 33A can be obtained.

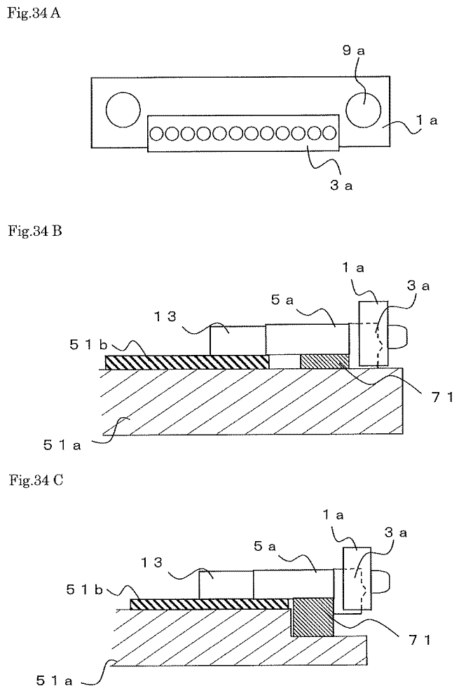

Also, FIG. 34A is a view showing another embodiment of the positioning member 1a. In an example shown in FIG. 34A, the positioning member 1a is not formed so as to surround an entire periphery of the lens array 3a, and the lens array 3a is exposed at a lower part of the positioning member 1a. That is, in the present embodiment, the positioning member 1a is joined to three surfaces, i.e., an upper surface and both side surfaces, of the lens array 3a. At this time, the positioning member 1a is formed such that a lower end of the lens array 3a slightly protrudes from a lower end of the positioning member 1a.

In such the case, as shown in FIG. 34B, it is possible to dispose a lower surface of the lens array 3a to be in contact with the substrate 51a. This can reduce the overall height. The glass 71 is disposed between the planar optical waveguide 5a and the substrate 51a.

Also, as shown in FIG. 34C, a level difference similar to the one mentioned above may be formed at the end part of the substrate 51a such that the positioning member 1a is disposed at the level difference part. Also in such the case, the glass 71 is disposed at the level difference part and the planar optical waveguide 5a or the lens array 3a is joined to the substrate 51a via the glass 71.

Also, FIG. 35A is a view showing another embodiment of the positioning member 1a. FIG. 35A is substantially similar to FIG. 34A except that it is configured such that the optical axis of the lens array 3a and an axial center of the guide mechanism 9a are at substantially the same height.

Also in such the case, as shown in FIG. 35B, it is possible to dispose the lower surface of the lens array 3a to be in contact with the substrate 51a. The glass 71 is disposed between the planar optical waveguide 5a and the substrate 51a. This can reduce the overall height.

Also, as shown in FIG. 35C, the level difference similar to the one mentioned above may be formed at the end part of the substrate 51a such that the positioning member 1a is disposed at the level difference part. Also in such the case, the glass 71 is disposed at the level difference part and the planar optical waveguide 5a or the lens array 3a is joined to the substrate 51a via the glass 71.

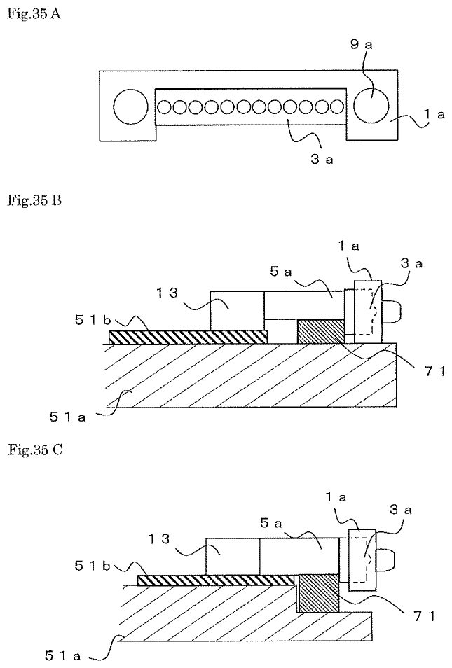

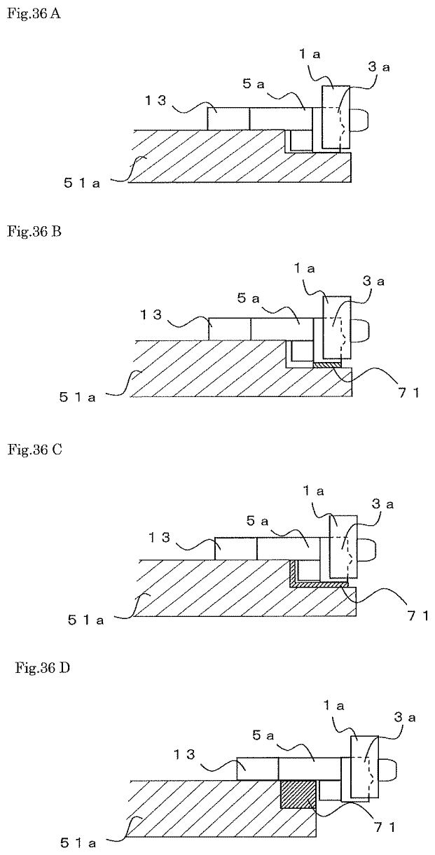

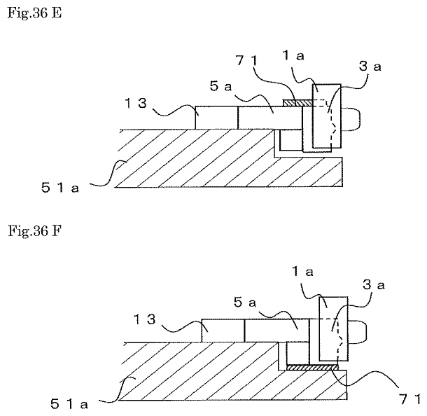

Also, as shown in FIG. 36A, the optical connection terminal 10 is directly connected to the substrate 51a without using the substrate 51b, and, furthermore, without using the glass 71, the lower surface of the lens array 3a may be in contact with the level difference part formed at the end part of the substrate 51a and fixed.

Also, an example shown in FIG. 36B has a substantially similar structure as the one in FIG. 36A except that the plate-like glass 71 is disposed between the lower surface of the lens array 3a and the upper surface of the level difference part of the substrate 51a.

Also, an example shown in FIG. 36C has a structure that is substantially similar to the one in FIG. 36B except that the glass 71 is disposed not only between the lower surface of the lens array 3a and the upper surface of the level difference part of the substrate 51a but also between the planar optical waveguide 5a and the upper surface of the level difference part of the substrate 51a. In such the case, the glass 71 is formed in a substantially L shape corresponding to a shape of the level difference part.

Also, as shown in FIG. 36D, the lens array 3a may be disposed so as to completely hang out from the end part of the substrate 51a and the glass 71 may be disposed between the substrate 51a and the planar optical waveguide 5a at the level difference part.

Also, as shown in FIG. 36E, the glass 71 may be disposed so as to be in contact with the upper surface of the lens array 3a and the upper surface of the planar optical waveguide 5a. This can reinforce the joint at each part.

Also, as shown in FIG. 36F, the glass 71 may be disposed at the lower surface of the lens array 3a and a lower part of the planar optical waveguide 5a. This can also reinforce the joint at each part. Note that, in FIG. 36A to FIG. 36F, it is also possible to configure the optical axis of the lens array 3a and the axial center of the guide mechanism 9a at substantially the same height.

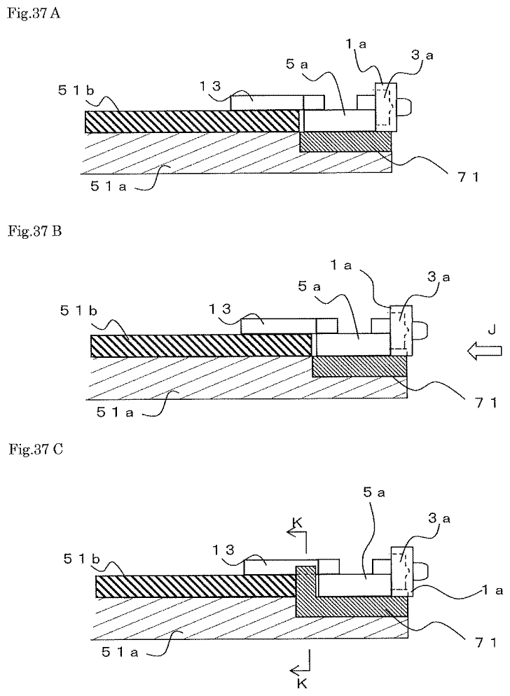

Also, in an example shown in FIG. 37A, the substrate 51b is disposed on the substrate 51a and the photonic integrated circuit 13 is disposed on the substrate 51b. Also, a level difference is formed on the substrate 51a, and the entirety of the planar optical waveguide 5a is disposed and fixed via the glass 71 at the level difference part. In such the case, the planar optical waveguide 5a and the positioning member 1a are fixed by adhesion to the glass 71.

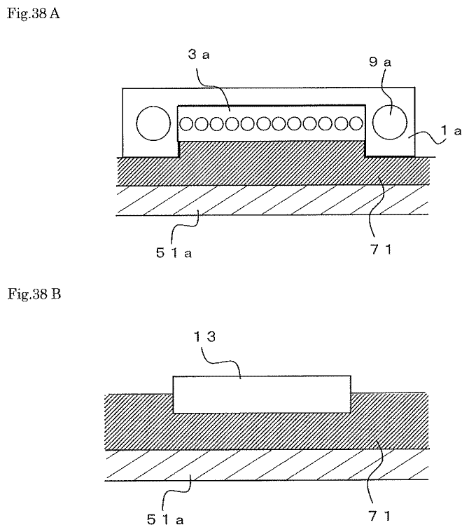

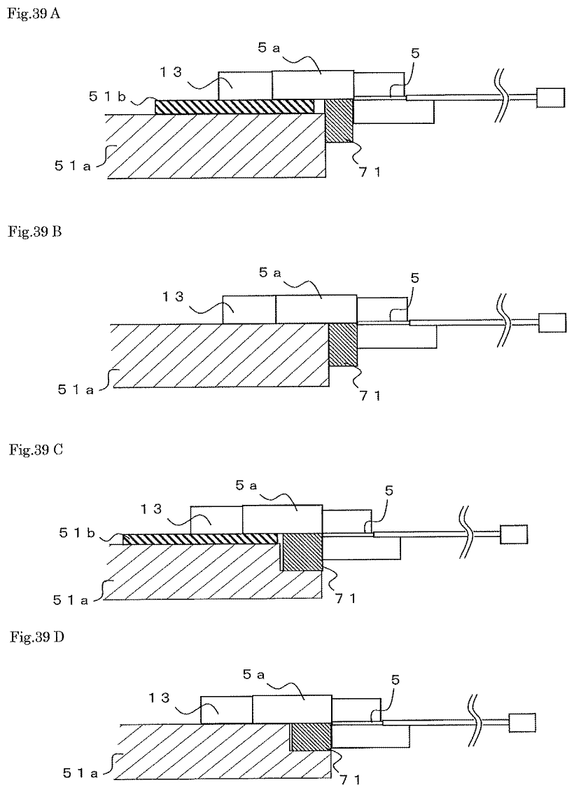

Also, in an example shown in FIG. 37B, with respect to FIG. 37A, a part of the glass 71 supports the positioning member 1a. FIG. 38A is a view from a direction of an arrow J in FIG. 37B. The glass 71 has a convex shape protruding upward at a part of a center part of a width direction thereof. The convex shape fits an insertion concave part of the positioning member 1a into which the lens array 3a is inserted. In such the case, the planar optical waveguide 5a, the positioning member 1a, and the lens array 3a are fixed by adhesion to the glass 71. Alternatively, the glass 71 and the lens array 3a may be configured integrally.

Also, in an example shown in FIG. 37C, with respect to FIG. 37B, a part of the glass 71 supports the photonic integrated circuit 13. FIG. 38B is a cross-sectional view taken along K-K line in FIG. 37C. The glass 71 has convex shapes protruding upward on both ends of the width direction thereof, and the convex shapes are in contact with both sides of the photonic integrated circuit 13, thereby supporting the photonic integrated circuit 13.

Also, in an example shown in FIG. 39A, instead of connecting the lens array 3a, the optical fiber array 5 is connected to the planar optical waveguide 5a. The photonic integrated circuit 13 is connected to the substrate 51a via the substrate 51b. The end part of the planar optical waveguide 5a is disposed so as to protrude from the end part of the substrate 51a, and the planar optical waveguide 5a is supported by the glass 71 that is disposed on the side end surface of the substrate 51a. A connector is connected to an end part of the optical fiber array 5. In such the case, the optical fiber array 5 is not detachable with respect to the substrate 51a.

Also, in an example shown in FIG. 39B, with respect to the example shown in FIG. 39A, the substrate 51b is not used and the photonic integrated circuit 13 is directly connected to the substrate 51a. Also in such the case, the end part of the optical planar optical waveguide 5a is disposed to be protruding from the end part of the substrate 51a, and the planar optical waveguide 5a is supported by the glass 71 that is disposed on the side end surface of the substrate 51a.

Also, in an example shown in FIG. 39C, with respect to the example shown in FIG. 39A, a level difference similar to the one mentioned above is provided at the end part of the substrate 51a and the glass 71 is disposed at the level difference part. Since the planar optical waveguide 5a is disposed above the level difference part, the planar optical waveguide 5a is supported above the level difference part by the glass 71.

Also, in an example shown in FIG. 39D, with respect to the example shown in FIG. 39B, a level difference is provided at the end part of the substrate 51a and the glass 71 is disposed at the level difference part. Since the planar optical waveguide 5a is disposed above the level difference part, the planar optical waveguide 5a is supported above the level difference part by the glass 71.

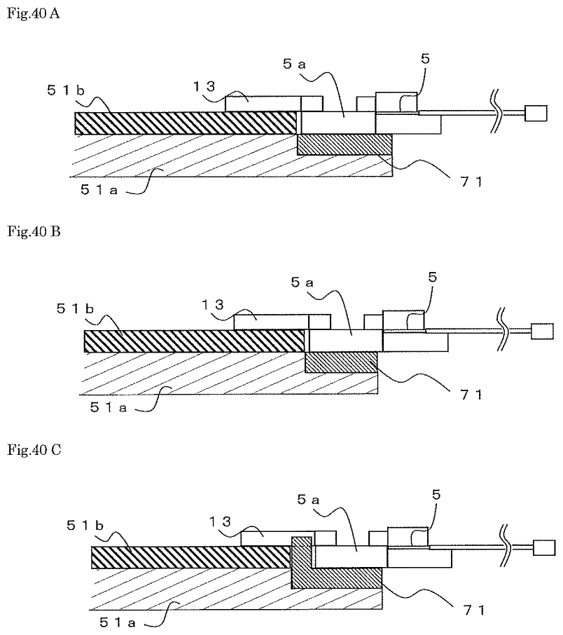

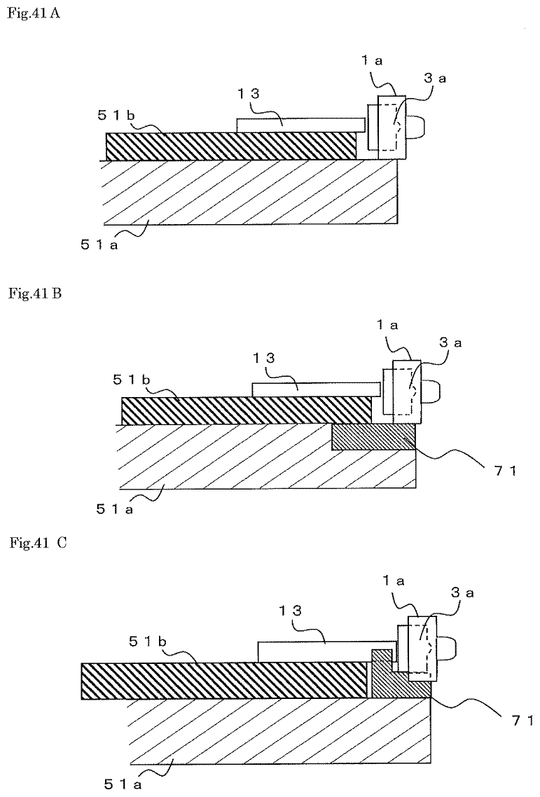

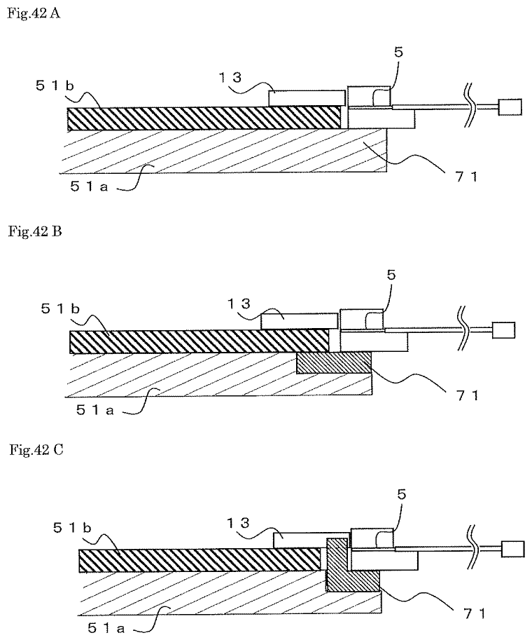

Also, in an example shown in FIG. 40A, similarly to FIG. 39A, the optical fiber array 5 is connected to the planar optical waveguide 5a. Also, the substrate 51b is disposed on the substrate 51a, and the photonic integrated circuit 13 is disposed on the substrate 51b. In addition, a level difference is formed on the substrate 51a, and the entirety of the planar optical waveguide 5a and a part of the optical fiber array 5 are disposed at the level difference and fixed via the glass 71.

Also, in an example shown in FIG. 40B, with respect to FIG. 40A, the optical fiber array 5 is disposed such that an entirety thereof hangs out of the level difference (the substrate 51a).

Also, in an example shown in FIG. 40C, with respect to FIG. 40B, a part of the glass 71 supports the photonic integrated circuit 13 (similarly to FIG. 38B). That is, the glass 71 has convex shapes protruding upward on both ends of the width direction thereof, and the convex shapes are in contact with both sides of the photonic integrated circuit 13, thereby supporting the photonic integrated circuit 13.

Also, in an example shown in FIG. 41A, the substrate 51b is disposed on the substrate 51a, and the photonic integrated circuit 13 is fixed onto the substrate 51b. The positioning member 1a is fixed at proximity of the end part of the substrate 51a. That is, the photonic integrated circuit 13 and the lens array 3a are optically connected without using the planar optical waveguide 5a.

Also, in an example shown in FIG. 41B, with respect to FIG. 41A, a level difference is formed at the end part of the substrate 51a, and the positioning member 1a is fixed to the level difference via the glass 71.

Also, in an example shown in FIG. 41C, with respect to FIG. 41B, a part of the glass 71 supports the positioning member 1a (similarly to FIG. 38A) and, at the same time, also supports the photonic integrated circuit 13 (similarly to FIG. 38B).

Also, in an example shown in FIG. 42A, with respect to FIG. 41A, the photonic integrated circuit 13 is connected to the optical fiber array 5. That is, the substrate 51b is disposed on the substrate 51a, and the photonic integrated circuit 13 is fixed onto the substrate 51b. The optical fiber array 5 is disposed in proximity of the end part of the substrate 51a and optically connected to the photonic integrated circuit 13.

Also, in an example shown in FIG. 42B, with respect to FIG. 42A, a level difference is formed at the end part of the substrate 51a, and the positioning member 1a is fixed to the level difference via the glass 71.

Also, in an example shown in FIG. 42C, with respect to FIG. 42B, a part of the glass 71 supports the photonic integrated circuit 13 (similarly to FIG. 38B).

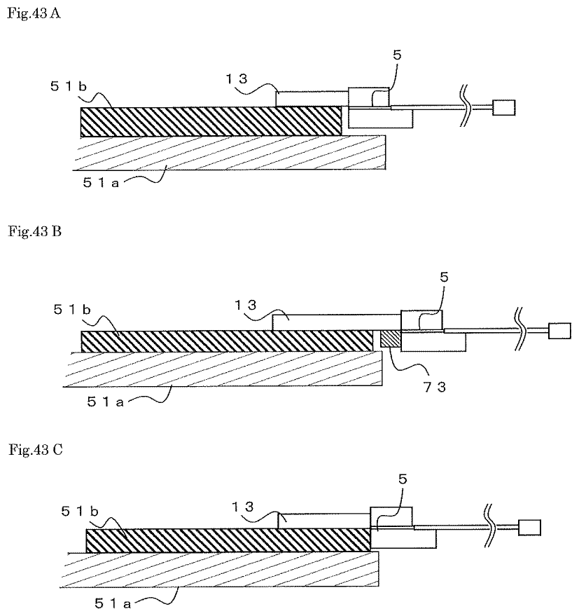

Also, in an example shown in FIG. 43A, with respect to FIG. 42A, the optical fiber array 5 is disposed without being in contact with the substrate 51a. That is, the substrate 51b is disposed on the substrate 51a, and the photonic integrated circuit 13 is fixed onto the substrate 51b. The optical fiber array 5 is fixed by adhesion to the end surface of the photonic integrated circuit 13 and optically connected to the photonic integrated circuit 13.

Also, in an example shown in FIG. 43B, with respect to FIG. 43A, the entirety of the optical fiber array 5 is disposed so as to hang out of the substrate 51a. A fixture 73 is fixed to a joint part between the photonic integrated circuit 13 and the optical fiber array 5. This can increase an adhesion area for the optical fiber array 5.

Also, in an example shown in FIG. 43C, with respect to FIG. 43A, the end surface of the optical fiber array 5 is joined not only to the end surface of the photonic integrated circuit 13 but also to an end surface of the substrate 51b. This can increase the adhesion area for the optical fiber array 5.

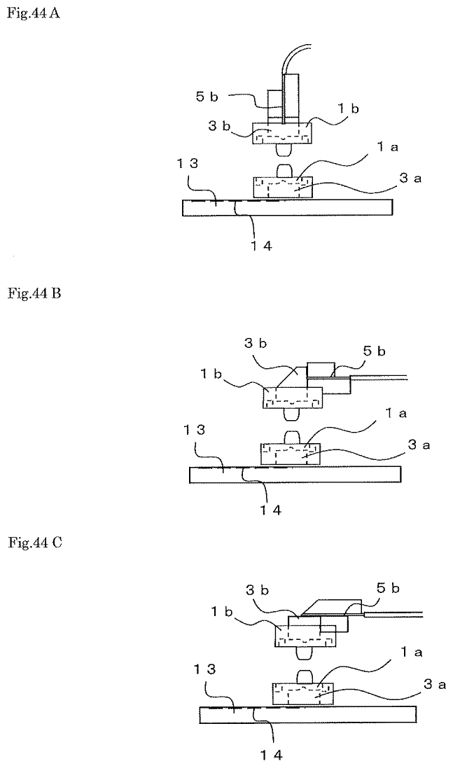

Also, in an example shown in FIG. 44A, with respect to the above-mentioned embodiments, a light emission direction from the photonic integrated circuit 13 is different. In drawings hereafter, drawings of the substrates will be omitted. As shown in FIG. 44A, the positioning member 1a is fixed onto an upper surface of the photonic integrated circuit 13. Also, an optical path 14 is provide on the upper surface of the photonic integrated circuit 13, and light is emitted upward from the photonic integrated circuit 13 to be incident at the lens array 3a. In such the case, the positioning member 1b is connected to the positioning member 1a from the upper part of the photonic integrated circuit 13 so as to face the positioning member 1a.

To direct the optical path 14 upward in the photonic integrated circuit 13, a mirror, a grating coupler, or the like (of which drawings are omitted) may be used, for example. Also, the light emission direction from the photonic integrated circuit 13 may not always be perpendicular to the upper surface of the photonic integrated circuit 13 and may be approximately 90°±10°, for example.

Also, in an example shown in FIG. 44B, with respect to FIG. 44A, the lens array 3b is in a different form. The incident light from the front of the lens array 3b is reflected at an approximately 45°-angled mirror part at a back surface of the lens array 3b to be emitted in an approximately 90° direction. That is, while the positioning members 1a and 1b are connected facing each other at the upper part of the photonic integrated circuit 13, the optical path 14 on the upper surface of the photonic integrated circuit 13 and the optical path in the optical fiber array 5b are substantially parallel to the upper surface of the photonic integrated circuit 13.

Also, in an example shown in FIG. 44C, with respect to FIG. 44B, the end surface of the optical fiber array 5b is cut obliquely, and, instead of being reflected at the back surface of the lens array 3b, the light is reflected at an incident part of the optical fiber array 5 so as to change the direction of the light. Also in such the case, while the positioning members 1a and 1b are connected facing each other at the upper part of the photonic integrated circuit 13, the optical path 14 on the upper surface of the photonic integrated circuit 13 and the optical path in the optical fiber array 5b are substantially parallel to the upper surface of the photonic integrated circuit 13.

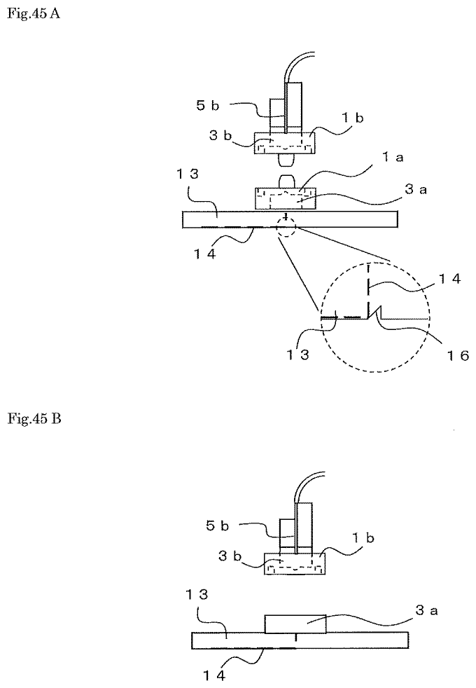

Also, in an example shown in FIG. 45A, the optical path 14 in the photonic integrated circuit 13 is formed not on the upper surface but on a lower surface side of the photonic integrated circuit 13. In such the case, for example, on the lower surface of the photonic integrated circuit 13, a reflective portion 16 may be formed at a position corresponding to the connected part with the lens array 3a so as to direct the optical path 14 upward.

Also, in an example shown in FIG. 45B, the lens array 3a is directly connected to the photonic integrated circuit 13. That is, the positioning member 1a is not used. Such the case is sufficient if positioning and connection with the lens array 3b are possible.

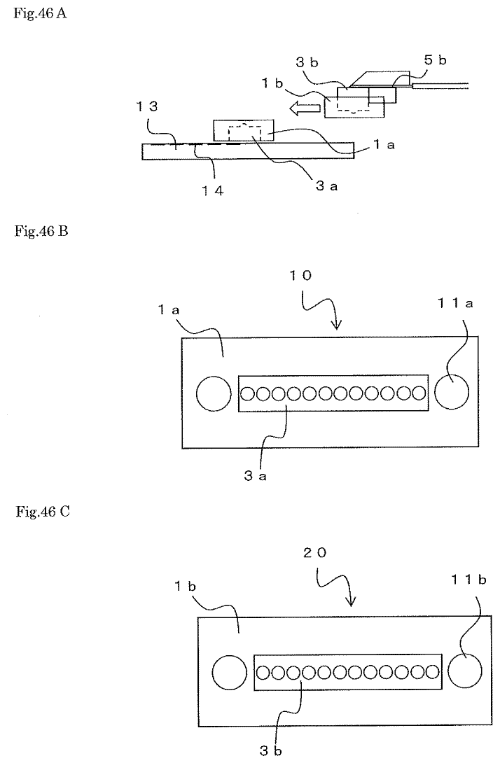

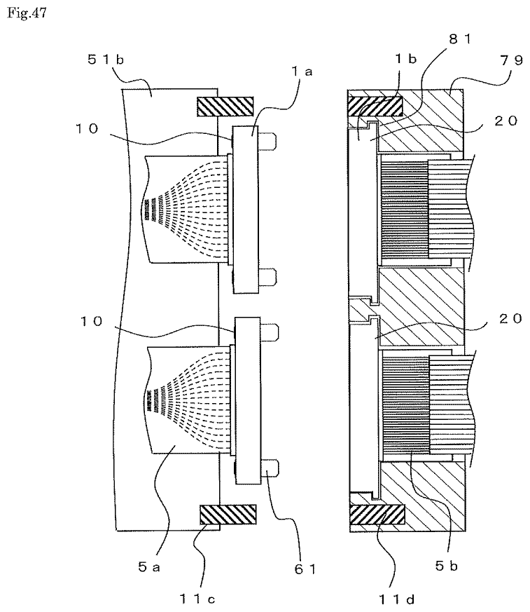

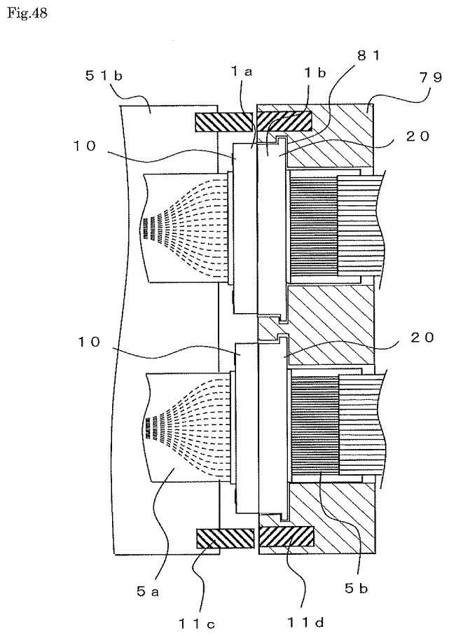

Also, in an example shown in FIG. 46A, the guide mechanisms 9a and 9b that can be fitted with each other in facing directions are not formed in the positioning members 1a and 1b. In such the case, as shown in FIG. 46B, the magnets 11a are formed on both side of the lens array 3a of the positioning member 1a, and, as shown in FIG. 46C, the magnets 11b are formed on both side of the lens array 3b of the positioning member 1b. That is, the magnets 11a and 11b attract each other so that the lens arrays 3a and 3b can be positioned.

By providing no fitting structures of concave/concave shapes on the facing surfaces of the positioning members 1a and 1b, the positioning member 1b can be slid from a side of the positioning member 1a for the connection operation as shown in FIG. 46A. Thus, the positioning members 1a and 1b can be connected to each other even if there is not enough space above the photonic integrated circuit 13, for example.

As above, various structures can be adopted for disposing the optical connection terminal 10 on the substrate 51a, and a method that allows the structure to be low in height and to enable stress relaxation during the temperature change is preferable.

Although connections between the pair of the optical connection terminal 10 and the optical connection terminal 20 have been described in the above embodiments, a plurality of pairs of the optical connection terminals may be performed simultaneously as shown below.

For example, in an example shown in FIG. 47, in a plan view, a plurality of the optical connection terminals 10 (the positioning members 1a) are provided side by side on the substrate 51b. The planar optical waveguide 5a may be fixed to the substrate 51a (of which drawing is omitted) without using the substrate 51b. Also, the planar optical waveguide 5a may be connected to the substrate via the photonic integrated circuit 13 instead of being directly connected to the substrate. Also, in the descriptions hereafter, although examples in which the two optical connection terminals are to be coupled will be shown, three or more connection terminals may also be coupled.

A plurality of the optical connection terminals 20 that can be connected to the respective optical connection terminals 10 are integrated by a housing 79. That is, in a plan view, the plurality of the optical connection terminals 20 are provided side by side in the housing 79. An optical connection terminal holder 81 corresponding to an outer shape of the optical connection terminal 20 is formed in the housing 79. At this time, by forming concave/convex shapes that can be fitted with the positioning member 1b and the optical connection terminal holder 81, the housing 79 holds the positioning member 1b with certainty.

In proximity of each end part of the housing 79, a magnet 11d is disposed. Also, a magnet 11c with a magnetic pole that can attract the magnet 11d is disposed at a position corresponding to the magnet 11d on the substrate 51b.

FIG. 48 is a view showing a state in which the optical connections terminals 10 and the optical connection terminals 20 are connected, respectively. By connecting the housing 79 to the substrate 51b through attraction between the magnets 11c and 11d, a plurality of pairs of the optical connections terminals 10 and the optical connection terminals 20 that are disposed facing each other are connected. Thus, compared to a case in which each of the optical connections terminals 10 and each of the optical connection terminals 20 are connected individually, the connection operation is easier.

By providing a gap between the magnet 11c and the magnet 11d when the optical connection terminals 10 and the optical connection terminals 20 are connected, the positioning members 1a and 1b can be brought into surface contact with more certainty. Also, instead of magnets 11c and 11d, a spring may be used to press and connect the housing 79 and the substrate 51b.

Also, by making the optical connection terminal holder 81 larger than the optical connection terminal 20 can form a small clearance between the optical connection terminal 20 and the housing 79. In this way, the optical connection terminal 20 can move slightly with respect to the housing 79. That is, a so-called floating structure can be formed at the time of connecting the positioning members 1a and 1b.

Arrangements of the optical connection terminals 10 and the optical connection terminals 20 may be reversed. That is, if a plurality of optical connection terminals are disposed on the substrate 51b, a plurality of the other optical connection terminals are fixed collectively to the housing 79. In this way, the plurality of optical connection terminals and the plurality of the other optical connection terminals integrated by the housing 79 can be optically connected.

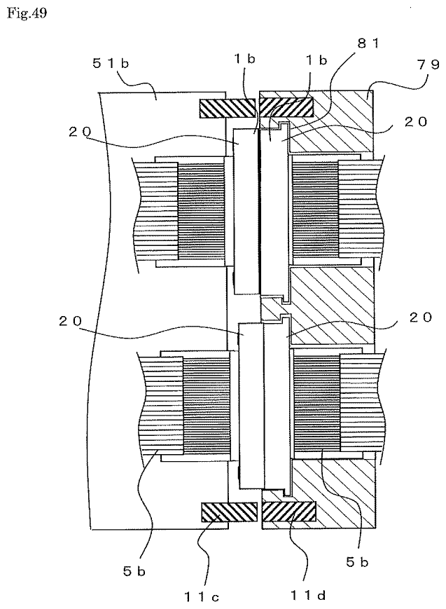

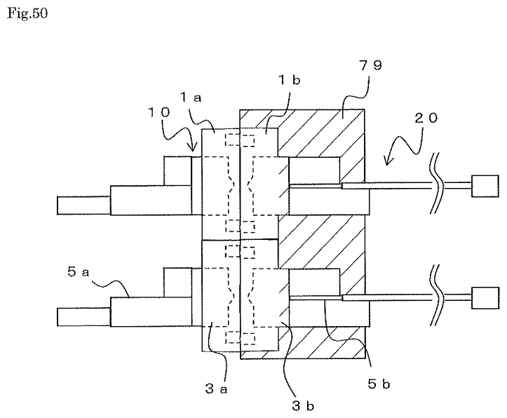

Also, as shown in FIG. 49, the plurality of the optical connection terminals 20 may be provided side by side on the substrate 51b and the housing 79 may collectively hold the plurality of the optical connection terminals 20. That is, the plurality of the optical connection terminals 20 may be connected to each other collectively.

Also, as shown in FIG. 50, the plurality of the optical connection terminals 10 may be provided side by side in a direction vertical to the substrate (of which drawing is omitted). That is, in a side view, the plurality of the optical connection terminals 10 may be provided side by side. In such the case, the plurality of the optical connection terminals 20 are provided side by side in a vertical direction and held collectively by the housing 79. The housing 79 is to be capable of holding the plurality of optical connection terminals that are provided side by side in a plan view or in a side view, depending on the arrangement of the optical connection terminals to be connected.

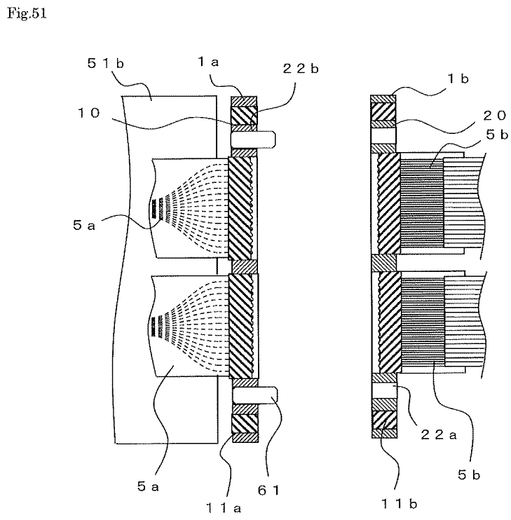

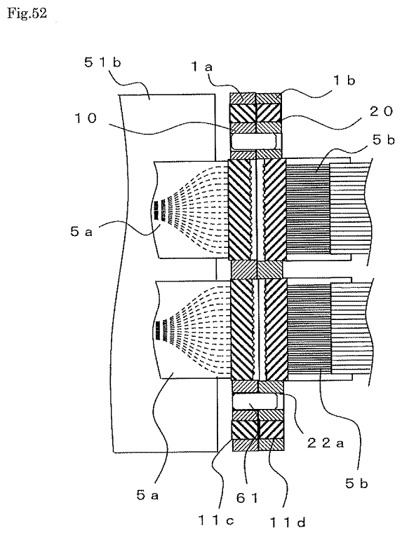

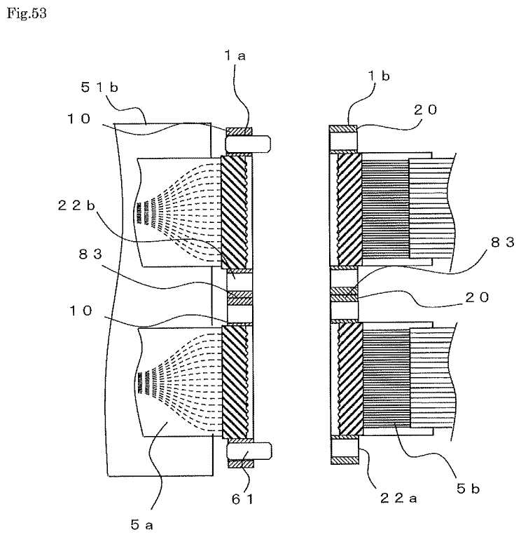

Also, in an example shown in FIG. 51, a plurality of the lens arrays 3a and the planar optical waveguides 5a are fixed to the one positioning member 1a. Also, a plurality of the lens arrays 3b and the optical fiber array 5b are fixed to the one positioning member 1b.

In more detail, in a plan view, the plurality of the lens arrays 3a are provided side by side in the positioning member 1a. The planar optical waveguide 5a is connected to each of the lens arrays 3a. Also, the guide pins 61 are disposed on both sides of the positioning member 1a with the plurality of the lens arrays 3a therebetween. Also, the magnets 11a are disposed in proximity of both end parts of the positioning member 1a.

Similarly, in a plan view, the plurality of the lens arrays 3b are provided side by side in the positioning member 1b. The optical fiber array 5b is connected to each of the lens arrays 3b. Also, the female-side holes 22a are disposed on both sides of the positioning member 1b with the plurality of the lens arrays 3b therebetween. Also, the magnets 11b are disposed in proximity of both end parts of the positioning member 1b.

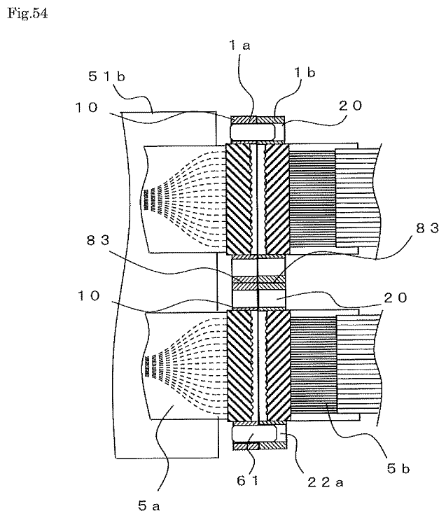

As shown in FIG. 52, by connecting the positioning members 1a and 1b, the plurality of the optical connection terminals 10 and the optical connection terminals 20 can be collectively connected. As mentioned above, the optical connection terminals 20 may be connected to each other. Also, the side-by-side direction of the optical connection terminals 10 and 20 may be horizontal or may be vertical.

Also, in an example shown in FIG. 53, a plurality of the positioning members 1a are coupled to each other at a coupling part 83. Also, a plurality of the positioning members 1b are coupled to each other at the coupling part 83. At the coupling part 83, the positioning members 1a, or the positioning members 1b, are adhered to each other by using adhesive or the like, for example. The guide pins 61 are fixed to the male-side holes 22b in proximity of both the end parts of the coupled positioning members 1a. That is, the guide pin 61 is unnecessary in the male-side holes 22b in proximity of the center part.

FIG. 54 is a view showing a state in which the plurality of the positioning members 1a and the plurality of the positioning members 1b are connected. The positioning members 1a and the positioning members 1b are connected by the magnets 11a and 11b, of which drawings are omitted. By coupling each other the plurality of the positioning members 1a and coupling each other the plurality of the positioning members 1b in this way, the pluralities of the optical connection terminals 10 and 20 can be collectively connected.

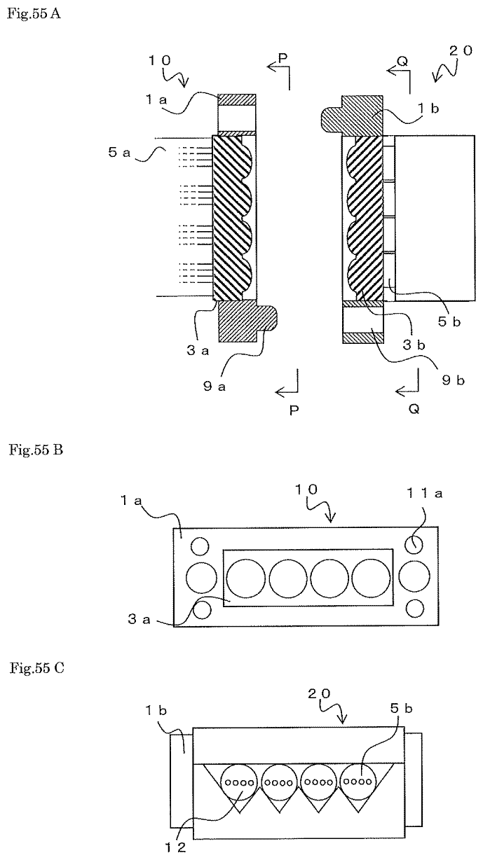

FIG. 55A is a view showing an example in which optical fibers in the optical fiber array 5b are multicore fibers. FIG. 55B is a view from a direction of an arrow P-P in FIG. 55A and FIG. 55C is a cross-sectional view taken along Q-Q line in FIG. 55A. Although the optical fiber array 5b includes four multicore fibers 12 in the illustrated example, the number of the multicore fibers 12 is not particularly limited. Also, although the example shows that four cores of the multicore fiber 12 are arranged in a straight line, the number or arrangement of the cores are not limited to the illustrated example.

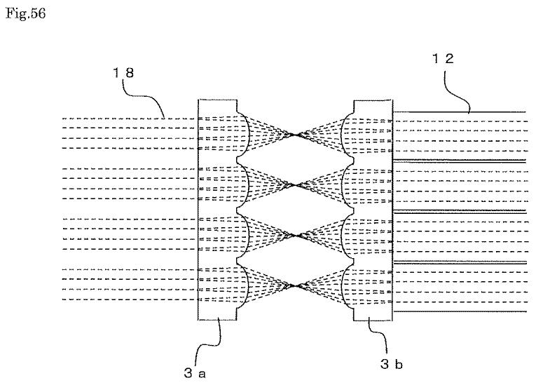

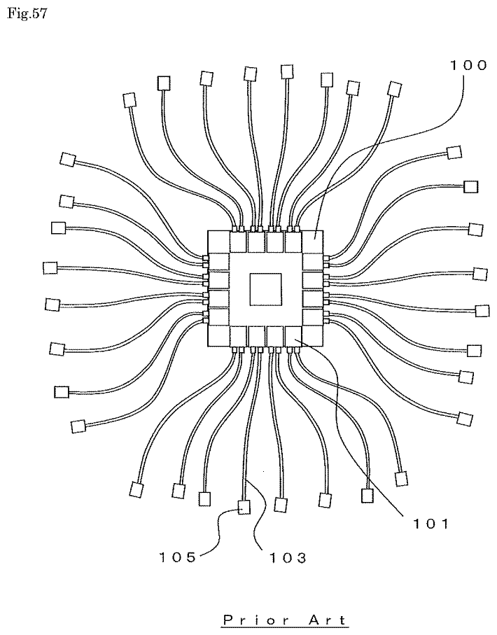

FIG. 56 is a schematic view of optical paths 18 at the time of optical connection in FIG. 55A. The multicore fiber 12 is connected to each lens of the lens array 3b, and light from the plurality of cores enters and exits the same lens. Similarly, in the lens array 3a, each lens is optically connected to the rear planar optical waveguide through a plurality of optical paths. In this way, the optical fibers in the optical fiber array 5b may include the plurality of multicore fibers 12 that are arranged side by side.

Although the embodiments of the present invention have been described referring to the attached drawings, the technical scope of the present invention is not limited to the embodiments described above. It is obvious that persons skilled in the art can think out various examples of changes or modifications within the scope of the technical idea disclosed in the claims, and it will be understood that they naturally belong to the technical scope of the present invention.

For example, it is needless to say that the structures in the respective embodiments can be combined with each other.

1. An optical connection terminal that can be optically connected to a connection target, the optical connection terminal comprising:
a positioning member having a guide mechanism for the connection target;
a lens array that is to be fixed to the positioning member; and
an optical waveguide member that is to be optically connected to the lens array, wherein:
the positioning member and the lens array are positioned and fixed to each other; and
the lens array and the optical waveguide member are aligned and fixed to each other.

2. The optical connection terminal according to claim 1, wherein:
the lens array and the optical waveguide member are made of silicon or glass; and
the positioning member is made of resin.

3. The optical connection terminal according to claim 1, wherein difference in linear expansion coefficients between the lens array and the optical waveguide member is 20 ppm/° C. or less.

4. The optical connection terminal according to claim 1, wherein;
the positioning member includes a positioning part with which a front surface of the lens array can be in surface contact; and
there is a predetermined distance between a tip end of the lens array and a front surface of the positioning member.

5. The optical connection terminal according to claim 1, wherein a magnet that is to be a fixing portion with the connection target is disposed on the front surface of the positioning member.

6. The optical connection terminal according to claim 1, wherein the guide mechanism is disposed on each side of the lens array and has a concave/convex structure that can be fitted with the connection target.

7. The optical connection terminal according to claim 1, wherein a gap is provided between the optical waveguide member and the lens array.

8. The optical connection terminal according to claim 7, wherein a spacer is disposed between the optical waveguide member and the lens array at a part other than optical paths.

9. The optical connection terminal according to claim 8, wherein the spacer and the lens array are integrally formed and a thickness of the spacer is 5 μm or more.

10. The optical connection terminal according to claim 1, wherein an interface between the optical waveguide member and the lens array is formed obliquely to an optical axis direction of the optical waveguide member.

11. The optical connection terminal according to claim 1, wherein optical waveguide paths in the optical waveguide member are formed obliquely to an optical axis direction of the lens array.

12. The optical connection terminal according to claim 1, wherein a beam expansion diameter by the lens array is 30 μm or more and 120 μm or less.

13. The optical connection terminal according to claim 12, wherein the front surface of the optical waveguide member is 5 μm or more behind a back focal point position of the lens array.

14. The optical connection terminal according to claim 12, wherein a thickness of the positioning member is 0.8 mm or more.

15. The optical connection terminal according to claim 14, wherein the thickness of the positioning member is 1 mm or more.

16. The optical connection terminal according to claim 1, wherein a distance between a rear end surface of the lens array and a front end surface of the positioning member is 1.7 mm or less.

17. The optical connection terminal according to claim 1, wherein a distance between a rear end surface of the optical waveguide member and the front end surface of the positioning member is 12 mm or less.

18. The optical connection terminal according to claim 1, wherein the lens array is inserted into the positioning member and fixed in a state in which outer surfaces of the lens array are pressed against at least two inner surfaces of the positioning member.

19. The optical connection terminal according to claim 1, wherein:
convex/concave shapes corresponding to each other are formed on the inner surfaces of the positioning member and the outer surfaces of the lens array; and
the convex/concave shapes on the inner surfaces of the positioning member fit with the convex/concave shapes on the outer surfaces of the lens array and the lens array is positioned to the positioning member.

20. The optical connection terminal according to claim 2, wherein:
convex/concave shapes corresponding to each other are formed on the inner surfaces of the positioning member and the outer surfaces of the lens array; and
when the lens array is pushed into the positioning member, the convex/concave shapes on the inner surfaces of the positioning member elastically deform such that the convex/concave shapes on the inner surfaces of the positioning member fit with the convex/concave shapes on the outer surfaces of the lens array to be fixed in a state of close contact with each other.

21. The optical connection terminal according to claim 1, wherein the optical waveguide member is an optical fiber array in which multicore fibers are arranged side by side.

22. The optical connection terminal according to claim 1, wherein a shrinkage percentage of the positioning member after being heated at 260° C. for one minute is 0.13% or less.

23. The optical connection terminal according to claim 1, wherein the shrinkage percentage of the positioning member after being heated at 260° C. for one minute is 0.02% or less.

24. A connection structure for optical connection terminals, wherein:
a first one of the optical connection terminals comprises a first positioning member, a first lens array that is to be fixed to the first positioning member, and a first optical waveguide member that is to be optically connected to the first lens array;
a second one of the optical connection terminals, which is to be connected to the first one of the optical connection terminals, comprises a second positioning member, a second lens array that is to be fixed to the second positioning member, and a second optical waveguide member that is to be optically connected to the second lens array; and
when the first positioning member and the second positioning member are connected, there is a space formed at an optically connected part between the first lens array and the second lens array.

25. The connection structure for optical connection terminals according to claim 24, wherein the first optical waveguide member is a planar optical waveguide and the second optical waveguide member is an optical fiber array.

26. The connection structure for optical connection terminals according to claim 24, wherein:
one side of the first positioning member and the second positioning member is provided with a male-side hole and a guide pin that is to be inserted into the male-side hole and fixed;
the other side of the first positioning member and the second positioning member is provided with a female-side hole into/from which the guide pin can be inserted/removed;
a diameter of the female-side hole is larger than a diameter of the male-side hole by 1 μm or more; and
when the first positioning member and the second positioning member are connected, the guide pin is inserted into the female-side hole and the first positioning member and the second positioning member are positioned to each other.

27. The connection structure for optical connection terminals according to claim 24, wherein:
one side of the first positioning member and the second positioning member is provided with a male-side hole and a guide pin that is to be pressed and fitted into the male-side hole and fixed;
the other side of the first positioning member and the second positioning member is provided with a female-side hole into/from which the guide pin can be inserted/removed;
a diameter of the female-side hole is larger than an outer diameter of the guide pin; and
when the first positioning member and the second positioning member are connected, the guide pin is inserted into the female-side hole and the first positioning member and the second positioning member are positioned to each other.

28. The connection structure for optical connection terminals according to claim 26, wherein an insertion length of the guide pin in the female-side hole is 1 mm or less.

29. The connection structure for optical connection terminals according to claim 24, wherein:
an interface between the first optical waveguide member and the first lens array is formed obliquely to an optical axis direction of the first lens array;
an interface between the second optical waveguide member and the second lens array is formed obliquely to an optical axis direction of the second lens array; and
when the first positioning member and the second positioning member are connected, the interface between the first optical waveguide member and the first lens array are substantially parallel to the interface between the second optical waveguide member and the second lens array.

30. The connection structure for optical connection terminals according to claim 24, wherein:
the interface between the first optical waveguide member and the first lens array is formed obliquely to the optical axis direction of the first lens array;
the interface between the second optical waveguide member and the second lens array is formed obliquely to the optical axis direction of the second lens array; and
when the first positioning member and the second positioning member are connected, the interface between the first optical waveguide member and the first lens array and the interface between the second optical waveguide member and the second lens array are substantially linearly symmetrical with a connected part as an axis of symmetry.

31. The connection structure for optical connection terminals according to claim 24, wherein:
an optical path of the first optical waveguide member is formed obliquely to the optical axis direction of the first lens array;
an optical path of the second optical waveguide member is formed obliquely to the optical axis direction of the second lens array; and
when the first positioning member and the second positioning member are connected, the optical path of the first optical waveguide member and the optical path of the second optical waveguide member are substantially linearly symmetrical with the connected part as an axis of symmetry.

32. The connection structure for optical connection terminals according to claim 24, wherein:
a plurality of the first ones of the optical connection terminals are disposed on a substrate;
a plurality of the second ones of the optical connection terminals are fixed collectively by a housing; and
the plurality of the first ones of the optical connection terminals are optically connected to the plurality of the second ones of the optical connection terminals that are integrated by the housing.

33. The connection structure for optical connection terminals according to claim 24, wherein:
the plurality of the first ones of the optical connection terminals are disposed on a substrate;
a plurality of the second lens arrays are fixed to the second positioning member in the second one of the optical connection terminals, and each of the second optical waveguide members is optically connected to each of the second lens arrays; and
each of the first lens arrays of the plurality of the first ones of the optical connection terminals and the plurality of the second lens arrays integrated by the second positioning member are optically connected.

34. A method for manufacturing an optical device using the connection structure for optical connection terminals according to claim 24, the method comprising:
a step ‘a’ of disposing the first one of the optical connection terminals onto an electronic circuit substrate to be connected with the electronic circuit substrate through reflow; and
a step ‘b’ following the step ‘a’ of connecting the second one of the optical connection terminals to the first one of the optical connection terminals.
